(19) United States
(12) Patent Application Publication
(10) Pub. No.: US 2016/0350873 A1
(43) Pub. Date: Dec. 1, 2016

(54) SYSTEM AND METHOD OF PROVIDING BUSINESS-TO-BUSINESS INTERACTION

(71) Applicants: Muhammad Tasneem Ul Hassan Nawaz, Mississauga (CA); Michael Scott DeMille, Whitby (CA)

(72) Inventors: Muhammad Tasneem Ul Hassan Nawaz, Mississauga (CA); Michael Scott DeMille, Whitby (CA)

(21) Appl. No.: 14/725,431

(22) Filed: May 29, 2015

(51) Int. Cl. G06Q 50/00; G06F 17/30

(52) U.S. Cl. CPC G06Q 50/01; G06F 17/3053; G06F 17/30554; G06F 17/30867

(57) ABSTRACT

Systems and methods are disclosed for providing business-to-business interaction. In one aspect, a method includes storing on a storage device, a plurality of organization profiles and a plurality of user accounts. Each organization profile may be associated with at least one user account. Each organization profile includes information about a corresponding organization received from a client device linked to a user account associated with that organization profile. The method further involves determining a ranking for each of a first organization profile and a second organization profile and displaying at a first client device linked a user account associated with the first organization profile, a first graphical user interface comprising the ranking for the second organization profile and the second organization profile. Other devices and methods and computer program products are also disclosed.

### FIELD

The present disclosure relates to the field of social networking, in particular, corporate social networking.

### INTRODUCTION

Currently, businesses may use an array of resources to locate partners and suppliers and to market themselves to potential customers. Such resources include online search tools, trade shows, advertisements, word of mouth, external agencies, and internal departments. Such resources may amount to significant time, money, and resources without satisfactory results.

Social interaction systems are frequently user-centric. Individuals may interact with other individuals. Some consumer-to-business interaction may be provided. However, there is a need for business-to-business interaction.

### SUMMARY

In accordance with at least one embodiment of the invention, there is provided a computer-implemented method for providing business-to-business interaction. The method involves in a system configured to host a webpage, the system including at least one processor and a memory, storing on a storage device, a plurality of organization profiles and a plurality of user accounts, each organization profile being associated with at least one user account, each organization profile including information about a corresponding organization; determining a ranking for each of a first organization profile and a second organization profile; and displaying, at a first client device linked to a user account associated with the first organization profile, a first graphical user interface including the ranking for the second profile and the second profile. The information about a corresponding organization may be received from a client device linked to a user account associated with that organization profile.

In at least one embodiment, the method may further involve determining a match rating between the first organization profile and the second organization profile using the first organization profile, the second organization profile, and the rankings for the first organization profile and the second organization profile; and the first graphical user interface further comprises the match rating.

In at least one embodiment, the method may further involve receiving an electronic message for the second organization profile from the first client device and displaying at a second client device linked providing to a user account associated with the second organization profile, the first organization profile, the ranking for the first organization profile, and the electronic message.

In at least one embodiment, each user account may be associated with one organization profile.

In at least one embodiment, the second profile may include information satisfying a search request; and the step of determining a match rating may further involve using the search request.

In at least one embodiment, the step of determining a match rating may further involve determining the search request based on the first organization profile.

In at least one embodiment, the step of determining a match rating may further involve receiving the search request from the first client device. The search request may include at least one of a search term and a search filter. The search term may include a text string received from the first client device. The search filter may include a pre-determined term selected at the first client device.

In at least one embodiment, the ranking may include at least one of an internal ranking and an external ranking. The step of determining a ranking for each organization profile may include determining a plurality of criterion for said organization profile and consolidating the plurality of criterion for said organization profile to obtain the ranking for said organization profile. The method may further involve storing, on the storage device the ranking for the first organization profile in association with the first organization profile; and storing, on the storage device, the ranking for the second organization profile in association with the second organization profile.

In at least one embodiment, the ranking may include an internal ranking and the plurality of criterion may include at least one of a subscription criterion and a marketing criterion. The information about a corresponding organization may further include at least one of a subscription selection and a marketing selection. The may further involve assessing the at least one of a subscription selection and a marketing selection to determine the at least one of a subscription criterion and a marketing criterion.

In at least one embodiment, the ranking may include an internal ranking and the plurality of criterion may include an endorsements criterion. The method may further involve receiving at least one endorsement for said organization profile from a client device linked to a user account associated with an organization profile that is distinct from said organization profile; storing, on the storage device, the at least one endorsement in association with said organization profile; and assessing the at least one endorsement in association with said organization profile to determine the endorsements criterion.

In at least one embodiment, the ranking may include an internal ranking and the plurality of criterion may include a profile criterion. The method may further involve storing, on the storage device, a creation date of said organization profile; and assessing said organization profile and the creation date of said organization profile to determine the profile criterion.

In at least one embodiment, the ranking may include an internal ranking and the plurality of criterion may include an activity criterion. The method may further involve maintaining, on the storage device, an activity log associated with said organization profile; and assessing the activity log associated with said organization profile to determine the activity criterion.

In at least one embodiment, the ranking may include an internal ranking and the plurality of criterion may include a contacts criterion. The method may further involve receiving at least one contact acceptance between said organization profile and at least one distinct organization profile that is distinct from said organization profile, the contact acceptance being received from a client device linked to a user account associated with at least one of said organization and the at least one distinct organization; storing, on the storage device, a contact connection for said organization profile in association with each of the at least one organization profile that is distinct from said organization profile of the at least one contact acceptance; and assessing contact connections for said organization profile to determine the contacts criterion.

In at least one embodiment, the ranking may include an external ranking. The step of determining a plurality of criterion for said organization profile may involve determining an industry identifier of said organization profile, and accessing a network to obtain information related to said organization profile and not stored on the storage device. The step of consolidating the plurality of criterion for said organization profile to obtain the ranking may be based on the industry identifier

In at least one embodiment, the ranking may include an external ranking and the plurality of criterion may include at least one of a financials criterion, a quality criterion, an innovation criterion, a corporate social responsibility criterion, a company longevity criterion, a pricing criterion, and a social media verification criterion. The step of accessing a network to obtain information related to said organization profile and not stored on the storage device may involve accessing at least one of a website hosted by an organization corresponding to said organization profile and a social media profile corresponding to said organization profile.

In at least one embodiment, the ranking may include an external ranking and the plurality of criterion may include at least one of a stock price criterion, a reputation criterion, the quality criterion, the innovation criterion, the corporate social responsibility criterion, a performance criterion, and the pricing criterion. The step of accessing a network to obtain information related to said organization profile and not stored on the storage device may involve accessing a website hosted a third-party organization that does not correspond to said organization profile.

In at least one embodiment, the ranking may include an internal ranking, and the plurality of criterion may include a growth criterion. The step of determining a plurality of criterion for said organization profile may involve storing, on the storage device, an initial external ranking for said organization profile in association with the first organization profile; determining an external ranking for said organization profile; and assessing the initial external ranking and the determined external ranking to determine the growth criterion.

In at least one embodiment, the method may further involve maintaining, on the storage device, a plurality of opportunity postings, each opportunity posting being associated with a posting organization profile and maintaining, on the storage device, a plurality of committed opportunities and a plurality of completed transactions, each committed opportunity and completed transaction being associated with at least two organization profiles. The method may further involve receiving an opportunity response corresponding to an opportunity posting and displaying at a posting client device linked to a user account associated with the posting organization profile of said opportunity posting, a posting graphical user interface comprising the opportunity response. The opportunity response may be received from a responding client device linked to a user account associated with a responding organization profile that is distinct from the posting organization profile. The method may further involve receiving a response acceptance corresponding to an opportunity response and an opportunity posting. The response acceptance may be received from the posting client device. The method may further involve removing, from the storage device, the opportunity posting from the plurality of opportunity postings; and storing, on the storage device, a committed opportunity in association with the responding organization profile and the posting organization profile. The method may further involve receiving an opportunity completion notice corresponding to a committed opportunity. The opportunity completion notice may be received from at least one of the posting client device and the responding client device. The method may further involve removing, from the storage device, the committed opportunity from the plurality of committed opportunities and storing, on the storage device, a completed transaction in association with the posting organization profile and the responding organization profile; and displaying, at the posting client device and the responding client device, an endorsements graphical user interface comprising an endorsement request.

In at least one embodiment, the step of determining a ranking for each of the first organization profile and the second organization profile may further involve receiving an opportunity request from the first client device. The second organization profile may be associated with a first opportunity posting satisfying the opportunity request. The first graphical user interface may further comprise a total number of opportunity postings associated with the second organization profile.

In at least one embodiment, the ranking may include an internal ranking. The step of determining a ranking for each organization profile may involve determining a plurality of criterion for said organization profile; and consolidating the plurality of criterion for said organization profile to obtain the ranking for said organization profile. The plurality of criterion may include a transactions criterion. The method may further involve assessing the opportunity postings, opportunity responses, committed opportunities and completed transactions in association with said organization profile to determine the transactions criterion.

In accordance with an embodiment of the invention, there is provided a non-transitory computer-readable storage medium having instructions stored thereon for execution by one or more processors for implementing a method involving storing on a storage device, a plurality of organization profiles and a plurality of user accounts, each organization profile being associated with at least one user account, each organization profile including information about a corresponding organization; determining a ranking for each of a first organization profile and a second organization profile; and displaying at a first client device linked to a user account associated with the first organization profile, a first graphical user interface including the ranking for the second organization profile and the second organization profile. The information about a corresponding organization may be received from a client device linked to a user account associated with that organization profile.

### DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram illustrating a system for providing business-to-business interaction, in accordance with at least one embodiment;

FIG. 2 is screen captures of a GUI that can be displayed on a client device for a user to create an organization profile or to edit an organization profile;

FIG. 3 is a block diagram illustration of a ranking manager used in the system of FIG. 1, in accordance with at least one embodiment;

FIGS. 4-A, 4-B, and 4-C show flowcharts illustrating methods of ranking, in accordance with at least one embodiment;

FIG. 5 is a block diagram illustration of a match manager used in the system of FIG. 1, in accordance with at least one embodiment;

FIG. 6 shows a flowchart illustrating a method of matching, in accordance with at least one embodiment;

FIG. 7 is a block diagram illustration of a search manager used in the system of FIG. 1, in accordance with at least one embodiment;

FIGS. 8-A and 8-B are a screen captures of graphical user interfaces (GUIs) that can be displayed on a display of a device for searching, in accordance with at least one embodiment;

FIGS. 9, 10-A, 10-B, and 10-C show flowcharts illustrating methods of searching, in accordance with at least one embodiment;

FIG. 11 is a block diagram illustration of a bid manager used in the system of FIG. 1, in accordance with at least one embodiment;

FIGS. 12-A, 12-B, and 12-C are screen captures of GUIs that can be displayed on a display of a client device for a user to perform commercial transactions, in accordance with at least one embodiment;

FIGS. 13-A, 13-B, 14-A, 14-B, and 14-C show flowcharts illustrating methods of opportunity posting and opportunity responding, in accordance with at least one embodiment;

FIGS. 14-D, 14-E, and 14-F show flowcharts illustrating methods of selling and buying, in accordance with at least one embodiment;

FIGS. 15-A and 15-B are screen captures of GUIs that can be displayed on a client device for a user to sign-on and navigate the system; and

FIG. 16 is a block diagram illustrating functions of a system for providing business-to-business interaction, in accordance with at least one embodiment.

The skilled person in the art will understand that the drawings, described below, are for illustration purposes only. The drawings are not intended to limit the scope of the applicants' teachings in anyway. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The various embodiments described herein generally relate to methods (and associated systems configured to implement methods) for providing business-to-business interaction. The method includes providing an environment that is a safe and secure place for organizations, companies, or businesses to market themselves to other organizations, companies, or businesses. The method also includes associating rankings to organizations and ratings to pairs of organizations. The method includes obtaining and using accurate, comprehensive, and reliable data to determine the rankings.

The method also includes providing an environment for organizations, companies, or businesses to engage in transactions. Transactions may generally refer to an exchange of goods or services. Transactions may include but are not limited to jobs, projects, tasks, or acquisitions. Transactions may begin as an opportunity. That is, a first organization may indicate that they are offering or seeking goods or services, which represents an opportunity for a second organization. A second organization may subsequently purchase or deliver the goods or services to the first organization and the exchange may be considered a transaction.

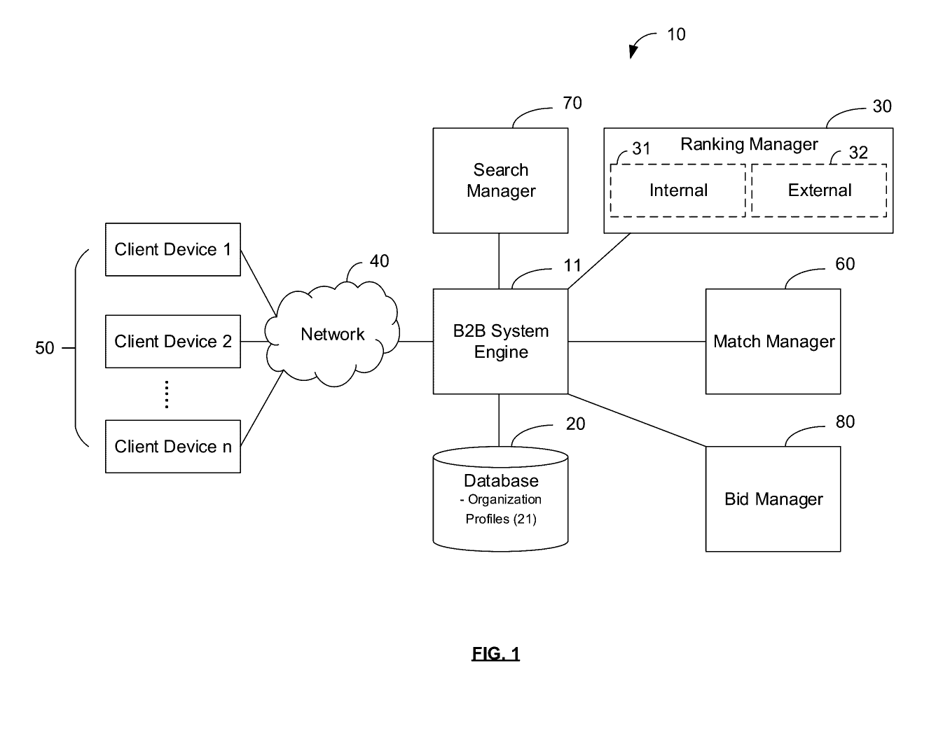

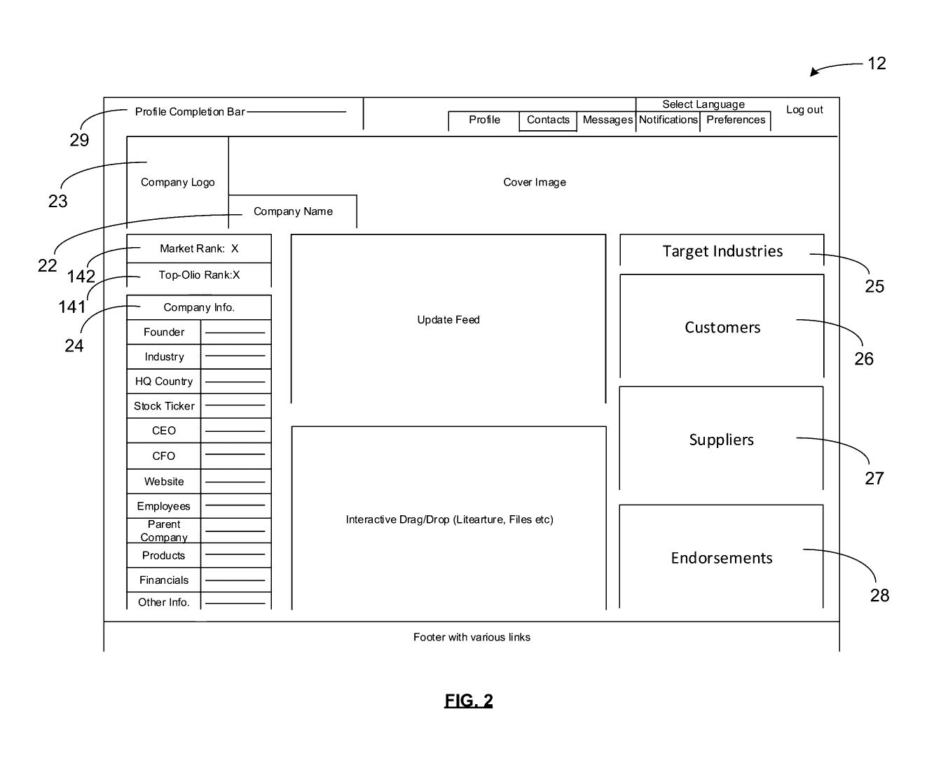

FIG. 1 is a block diagram illustrating an exemplary embodiment of a system for providing business-to-business interaction, referred to generally as 10. The system 10 may include a B2B System Engine 11, a database 20, a ranking manager 30, a match manager 60, a search manager 70, and a bid manager 80. Generally, a user at a client device 50 can communicate with the B2B System Engine 11 across network 40 to create an organization profile 21, relating to their associated organization, business, or company. Each profile 21 is stored in the database 20. Users from different organization profiles 21, or companies, may subsequently locate and interact with one another.

Steps may be described as being performed by companies. However, it will be understood that such steps are performed by users on behalf of a company that they are associated with. For example, when users from different companies interact with one another, it can be said that companies interact with one another.

Multiple users may be associated with a single profile 21. In some embodiments, each user may be associated with only one profile 21. In some embodiments, each user may be associated with more than one profile 21. For example, a user, or a person, may simultaneously hold two different positions at two different companies. The number of users that may be associated with a single profile 21 may be limited, depending on a subscription category associated with the organization profile 21. Example subscription categories include free, good, better, best, or premium.

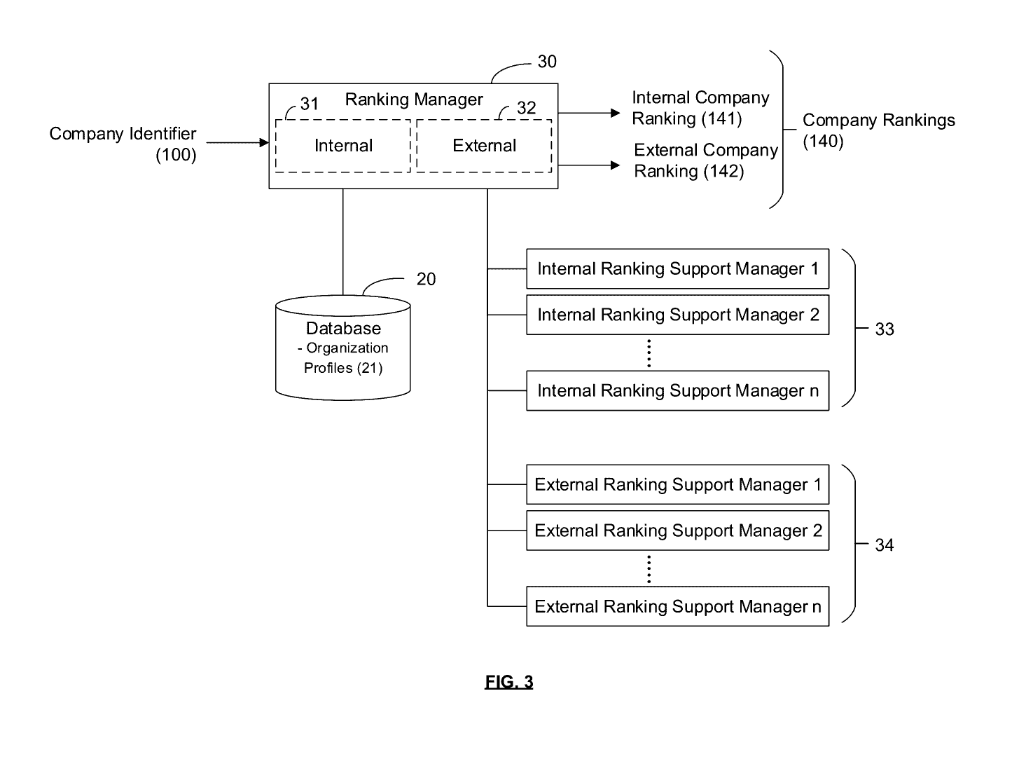

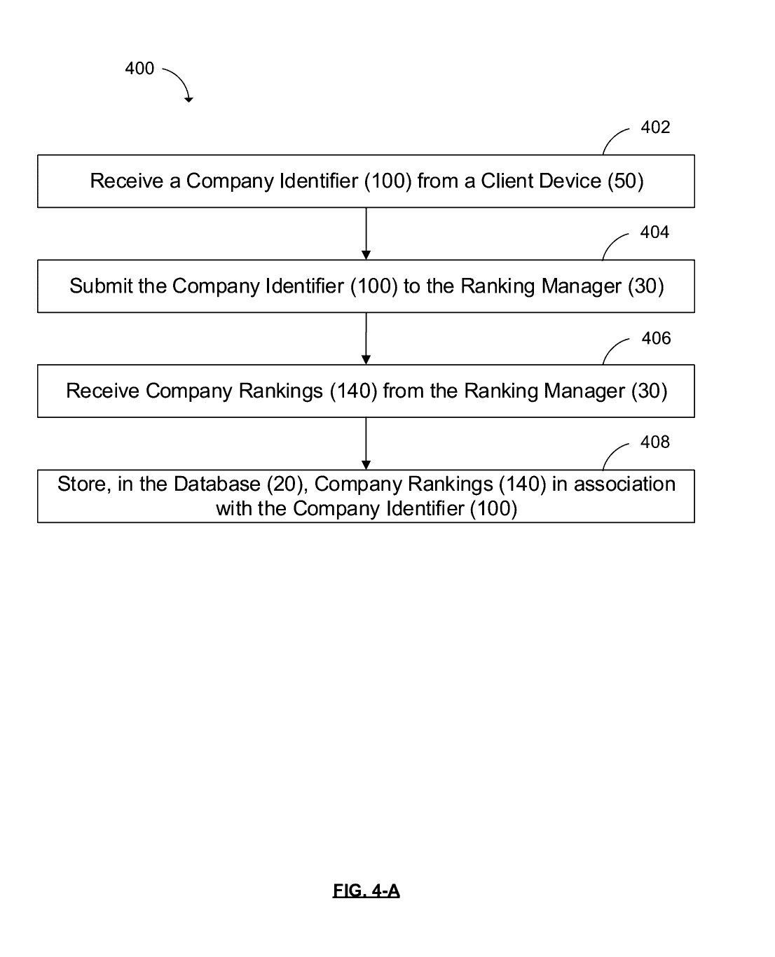

FIG. 2 shows a screen capture of a graphical user interface (GUI) 12 that can be displayed on a display of a client device 50 to enable a user to create an organization profile 21 or to edit an organization profile 21, in accordance with at least one embodiment. Each profile 21 may be stored in the database 20 and associated with a unique profile, or company identifier 100. An organization profile 21 may include a company name 22, a company logo 23, an external company ranking 142 (shown as market rank), an internal company ranking 141 (shown as a Top-Olio™ Rank), company information 24, and target industries 25. Company information 24 may include a description of the company (e.g. profile summary), the date that the company was formed, the company's industry, location of company headquarters, stock ticker, names of the founders or executives (e.g., chief executive officer, chief financial officer, and chief technology officer), website, range or number of employees, parent company, products, financials, and other information.

Target industries 25 may include customers 26 and suppliers 27. An organization profile 21 may also be associated with privacy settings, endorsements 28, a profile completion status 29, and media. The profile completion status 29 may generally relate to whether information is available for the organization profile. Some profile information may be considered to be more essential than other information. Media may include any news coverage or media content, including social media feeds, about the company. Media content 29 may be provided in any appropriate form such as text or video.

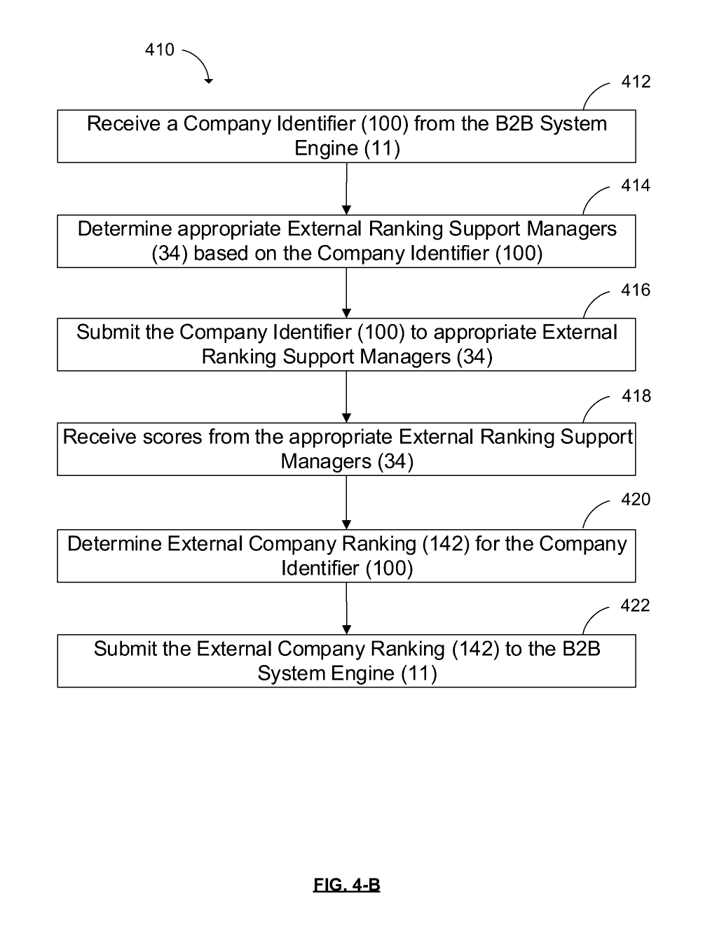

FIG. 3 shows a block diagram illustration of the ranking manager 30 used in the system 10 of FIG. 1, in accordance with at least one embodiment. The ranking manager 30 may determine a company ranking 140 for an organization profile 21 stored in the database 20. The ranking manager 30 may receive the company identifier 100, associated with an organization profile 21 stored in the database 20. In some embodiments, the ranking manager 30 may use ranking support managers 33 and 34 to determine the company ranking 140.

A company ranking 140 generally relates to any appropriate rating scale. In some embodiments, the company ranking 140 may be a qualitative rating, such as a probability, a 10-point basis, or a “star” system.

In some embodiments, the company ranking 140 may be an internal company ranking 141 or an external company ranking 142, or a combination of the internal company ranking 141 and external company ranking 142. When the ranking manager 30 uses information within the system 10 to determine a company ranking 140, the company ranking 140 may be an internal company ranking 141 and the ranking manager 30 may be called an internal ranking manager 31. The system 10 may be configured to offer additional features and incentives based on the internal company ranking 141.

When the ranking manager 30 accesses the network 40 to obtain information external to the system 10 for determining a company ranking 140, the company ranking 140 may be an external company ranking 142 and the ranking manager 30 may be called an external ranking manager 32. Within the system 10, the external company ranking 142 may provide an indicator of market data related to that profile 21.

Using information external to the system 10, the external company ranking 142 may be determined based on various criteria including but not limited to criteria for financials, stock price, reputation, quality, innovation, performance, corporate social responsibility, social media, company longevity, and price. External ranking support managers 34 may be provided to determine each or some of these criteria.

An external company ranking 142 may be determined by accessing information from the company's external information, third party information, and social media information. The company's external information includes any information available from the company's website, including annual reports and press releases. Third party information includes test results, publications of analyses, and any other rankings. Social media information includes information obtained from other social media websites such as Facebook™ and Twitter™.

In some embodiments, the company's external information may be used to determine financials, quality, corporate social responsibility, company longevity, pricing, and innovation. In some embodiments, third party information may be used to determine various criteria including stock price, reputation, innovation, quality, corporate social responsibility, performance, and price. In some embodiments, social media information may be used to determine a criterion related to social media.

The financials criterion may relate to a company's revenue, profit, and growth. The reputation and performance criterion may relate to rankings by third party publications such as Forbes™, Better Business Bureau™, Consumer Reports™, and other business reports. The quality criterion may relate to the company's published statistics and press releases, such as recalls and product notices. The innovation criterion may relate to the company's publications, patents, and other third-party reviews in publications, magazines, or consumer reports. The corporate social responsibility criterion may relate to air pollution, energy usage, recyclability of materials, and the general environmental impact of the company. The social media criterion may relate to whether the company's profile on various social media platform has been verified and their influence or clout (e.g., number of followers, contacts, frequency of tweets, postings, or status updates). The company longevity criterion may relate to the longevity of the company relative to the industry. The price criterion may relate to the general price range of the company's products relative to the industry.

The external company ranking 142 may be determined by any appropriate model or algorithm. For example, the external company ranking 142 may be determined using a weighted sums model. In at least one embodiment, the external company ranking 142 may be determined using a weighted product model. In at least one embodiment, the external company ranking 142 may be determined using a statistical model.

In addition, the model or algorithm may depend on the organization profile 21 that is being ranked. In some embodiments, the external company ranking 142 may depend on the industry in which the organization, business, or company operates. For example, the company longevity criteria may be a more important factor for the automotive industry than the software application industry. Accordingly, the weighting, or impact, associated with the company longevity criteria may be greater, or higher, for a company in the automotive industry than that of a company in the software application industry.

In some embodiments, the external company ranking 142 may depend on the geographic location of the organization, business, or company. For example, the social media verification criteria may be a more important factor for countries where social media is more widely used than other countries. In some embodiments, the external company ranking 142 may not include the stock price criterion. For example, company information 24 may indicate that the organization is a private company or non-profit organization. In such cases, a stock price criterion may not be an appropriate criterion for the external company ranking 142.

Each criteria of the external company ranking 142 may have a different importance, based on any company information 24 and target industries 25 of that profile 21. That is, the external company ranking 142 for some target industries 25 or other company information 24 may be based on a subset of the various criteria for financials, stock price, reputation, quality, innovation, performance, corporate social responsibility, social media, company longevity, and price. Furthermore, a subset of the various criteria may be obtained by setting weightings to zero. In the example of a private company, the weighting associated with the stock price criterion may be set to zero.

An example of an external company ranking 142 for a global tire manufacturer using a weighted sums model is provided in Table 1. A score for each criterion may be first determined based on a 10-point scale. The various criteria are then consolidated and an appropriate weighting may be applied to determine the external company ranking 142.

TABLE 1

| Criteria | Weighting | Score |
|---|---|---|
| Financials | 20% | 7 |
| Stock Price | 15% | 7 |
| Reputation | 10% | 8 |
| Quality | 10% | 9 |
| Innovation | 10% | 8 |
| Performance | 10% | 7 |
| Corporate Social Responsibility | 10% | 4 |
| Company Longevity | 10% | 10 |
| Price | 5% | 4 |

| | |
|---|---|
| External Company Ranking 142 | 73 |

The skilled person in the art will understand that the weightings may be adjusted occasionally. Weightings may be adjusted for a variety of reasons including but not limited to industry-level changes, general business market changes, and technology changes. For example, while social media is currently a widely used tool, it may in the future become obsolete. Furthermore, determination of a score may also be adjusted occasionally. For example, when a spread of scores for a given criteria in an industry is small, the determination of scores for that criteria may be adjusted to better distinguish amongst companies in that industry. That is, if all companies in an industry have a quality score in a small range (e.g., range from 0 to 1), the determination of the quality score may be adjusted to better distinguish between the companies (e.g., range from 0 to 5).

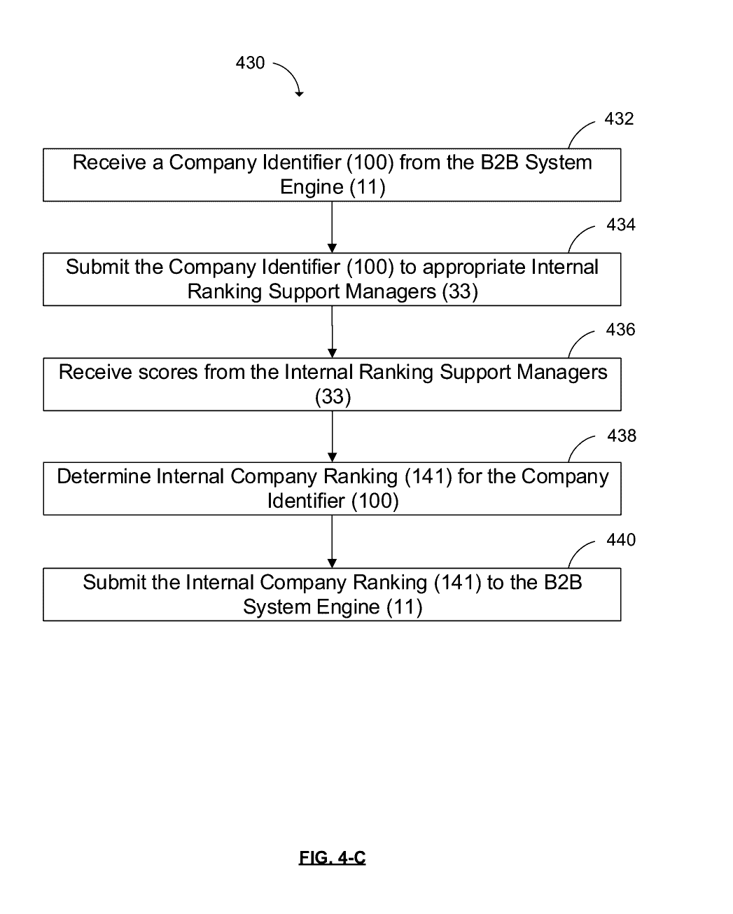

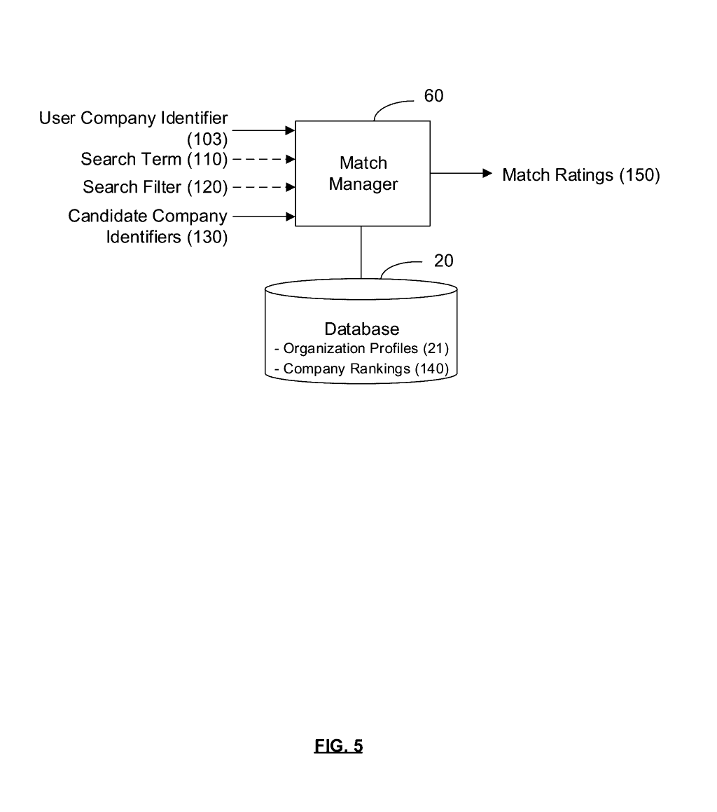

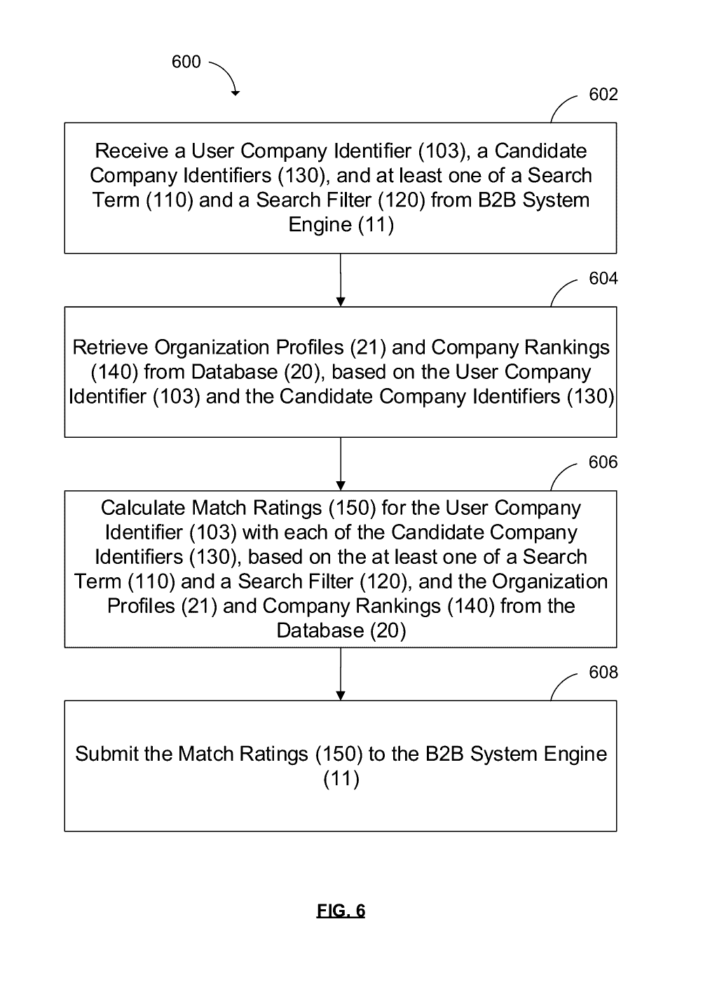

Referring to FIGS. 4-A to 4-C, illustrated therein are flowcharts showing the steps of the ranking process, in accordance with an embodiment of the present disclosure. The ranking process generally involves the B2B System Engine 11 and the ranking manager 30.

FIG. 4-A illustrates the steps of the ranking process performed by the B2B System Engine 11, referred to generally as 400. At step 402, a client device 50 initiates the ranking process with the B2B System Engine 11. This may be performed by a user using a web browser executing on the client device 50 to access a website made available by the B2B System Engine 11. Alternatively, the client device 50 may be executing a standalone B2B application (e.g., a dedicated application executing on the client device 50). The B2B System Engine 11 receives a company identifier 100 from the client device 50.

At step 404, the B2B System Engine 11 submits the received company identifier 100 to the ranking manager 30. At step 406, the B2B System Engine 11 receives the company ranking 140 from the ranking manager 30. At step 408, the B2B System Engine 11 stores the company ranking 140 in association with the company identifier 100 in the database 20. In some embodiments, the B2B System Engine 11 may further display the company ranking 140 at the client device 50.

FIG. 4-B illustrates the steps of the ranking process performed by the external ranking manager 32, referred to generally as 410. In response to step 404, the external ranking manager 32 receives a company identifier 100 from the B2B System Engine 11 at step 412.

At step 414, the external ranking manager 32 determines the appropriate external ranking support managers 34 based on the company identifier 100. The external ranking manager 32 may use the company identifier 100 to determine profile information 24 and target industries 25 and an appropriate model or algorithm for the external company ranking 142. For instance, the external ranking manager 32 may determine that the company identifier 100 relates to a global tire manufacturer. Based on the weighted sum model of Table 1, the external ranking manager 32 may determine that the external ranking support managers 34 providing scores for financials, stock price, reputation, quality, innovation, performance, corporate social responsibility, company longevity, and price are required. However, the external ranking support manager 34 providing a score for social media verification is not required.

At step 416, the external ranking manager 32 submits the company identifier 100 to the appropriate external ranking support managers 34. In response, the external ranking support managers 34 determine scores for the respective criterion and, at step 418, the external ranking manager 32 receives the scores.

At step 420, the external ranking manager 32 determines an external company ranking 142 based on the scores received from the external ranking support managers 34. At step 422, the external ranking manager 32 submits the external company ranking 142 to the B2B System Engine 11.

Using information within the system 10, the internal company ranking 141 may also be determined based on various criteria related to system 10 features. For example, the system 10 may require a subscription in order to create an organization profile 21. The system 10 may also enable companies to advertise or carry out transactions within the system. Criteria may include, but is not limited to, subscription, marketing, transactions, endorsements 28, profile completion status 29, time online, contacts, and growth of external company ranking 142. The time online criteria may relate to how long a company has had an organization profile 21 in the system 10, the daily activity in the system 10, or a combination of both. Internal ranking support managers 33 may be provided to determine each or some of these criteria.

The internal company ranking 141 may be determined by any appropriate model or algorithm. For example, the internal company ranking 141 may be determined using a weighted sums model. Unlike the external company ranking 142, the model used to determine the internal company ranking 141 may not depend on the organization profile 21 that is being ranked. That is, the model used for the internal company ranking 141 may be the same for all organization profiles 21 stored in the database 20.

An example of an internal company ranking 141 using a weighted sums model is provided in Table 2. A score for each criterion may be first determined based on a 10-point scale. The various criteria are then consolidated and an appropriate weighting may be applied to determine the internal company ranking 141.

TABLE 2

| Criteria | Weighting | Score |
|---|---|---|
| Subscription | 15% | 5 |
| Marketing | 15% | 8 |
| Transactions | 15% | 7 |
| Endorsements | 15% | 6 |
| Profile Completion Status | 10% | 6 |
| Time Online | 10% | 4 |
| Contacts | 10% | 8 |
| Growth of External Company Ranking | 10% | 2 |

| | |
|---|---|
| Internal Company Ranking 141 | 59 |

FIG. 4-C illustrates the steps of the ranking process performed by the internal ranking manager 32, referred to generally as 430. In response to step 404, the internal ranking manager 31 receives a company identifier 100 from the B2B System Engine 11 at step 432.

At step 434, the internal ranking manager 31 submits the company identifier 100 to the appropriate internal ranking support managers 33. In response, the internal ranking support managers 33 determine scores for the respective criterion and, at step 436, the internal ranking manager 33 receives the scores. At step 438, the internal ranking manager 31 determines an internal company ranking 141 based on the scores received from the internal ranking support managers 33. At step 440, the internal ranking manager 32 submits the internal company ranking 141 to the B2B System Engine 11.

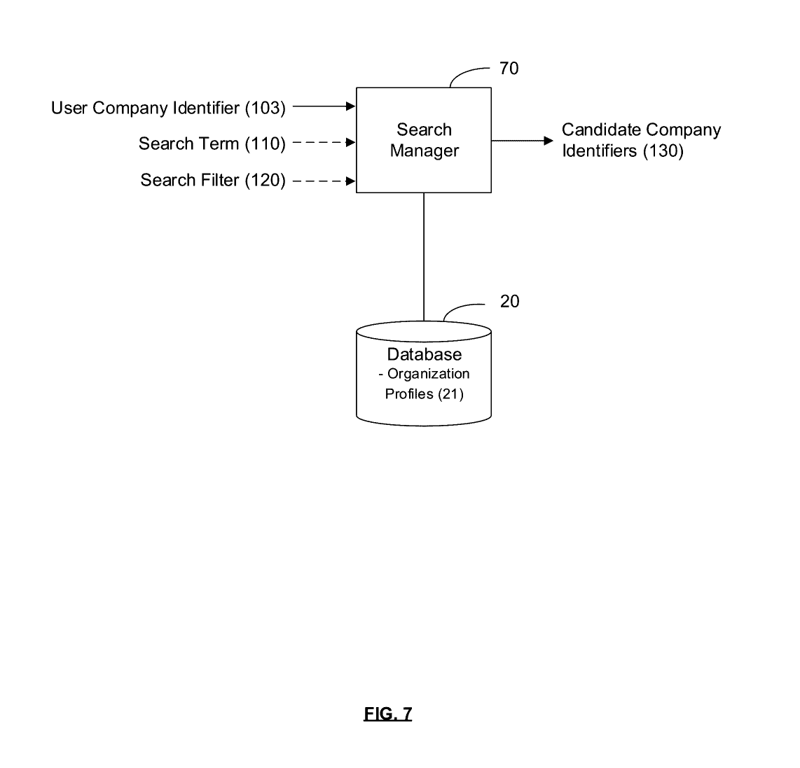

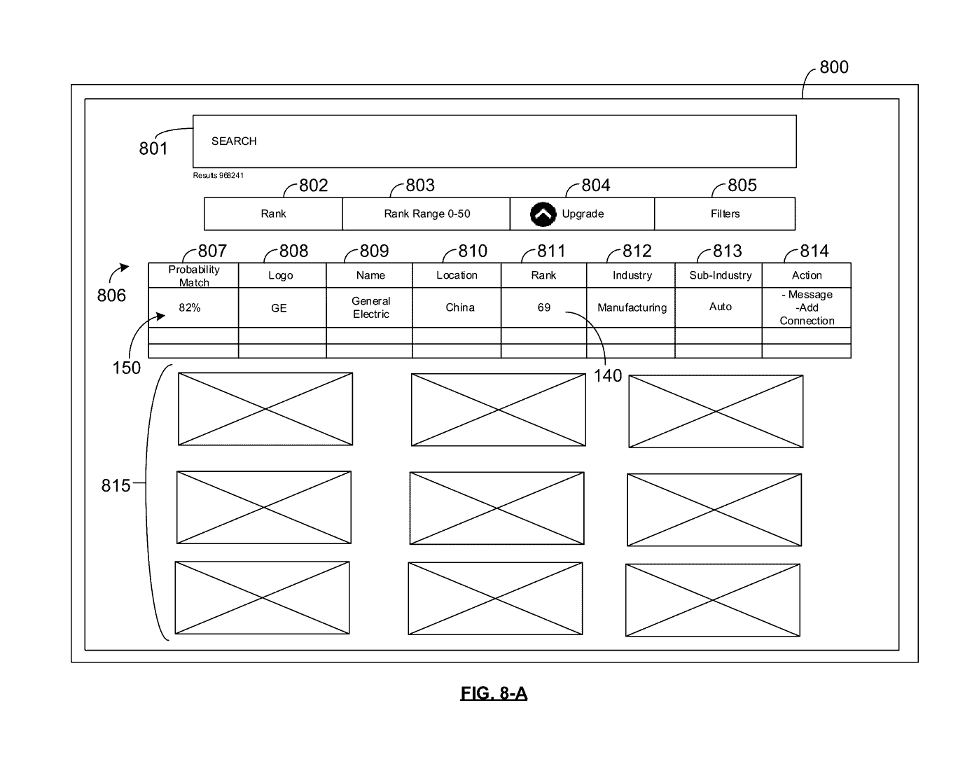

FIG. 5 shows a block diagram illustration of the match manager 60 used in the system 10 of FIG. 1, in accordance with at least one embodiment. The match manager 60 may determine a match rating 150 between two organization profiles 21 stored in the database 20. The match manager 60 may receive a plurality of company identifiers, each of the company identifiers being associated with an organization profile 21 stored in the database 20. A first company identifier may be referred to as the user company identifier 103 and additional company identifiers may be referred to as candidate company identifiers 130.

A match rating 150 may relate to any appropriate rating scale. In some embodiments, the match rating 150 may be a qualitative rating, such as a probability, a 10-point basis, or a “star” system. In some embodiments, the match rating 150 may be a quantitative rating (e.g., recommended, not recommended) or color scheme (e.g., green, yellow, or red).

The match rating 150 may be used to support other features within the system 10. Accordingly, the matching process to determine a match rating 150 may be initiated by another feature within the system 10, such as the search process or the commercial transaction process, each of which will be described in greater detail below. For example, a user at a client device 50 associated with a first company may use the system 10 to search for a company to connect with, or contact, in a particular industry. The search results may be organized accordingly to how well companies in that industry would match with the first company. The match rating 150 may be determined based on various criteria including the search itself and the respective company rankings 140 and organization profiles 21. For example, the match rating 150 may depend on the geographic location, the size of the company, or any other information found in the organization profiles 21. The match rating 150 may depend on the company ranking 140, company longevity, or transactions, or any other information related to company rankings 140.

When the matching process is initiated by the search process, a search term 110 or a search filter 120, or both, used in the search process may also be used in the matching process. Accordingly, the match manager 60 may also receive a search term 110 or a search filter 120, or both.

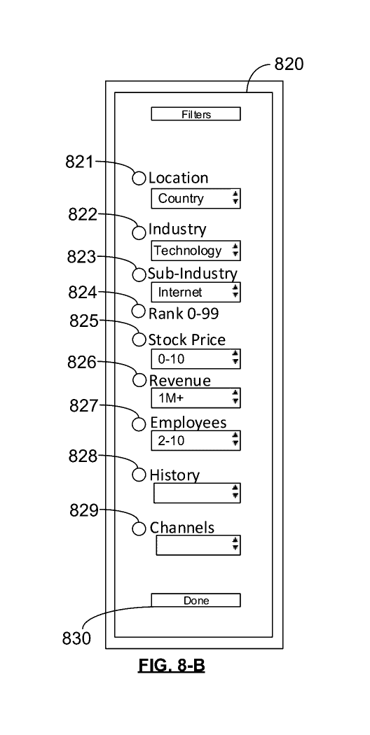

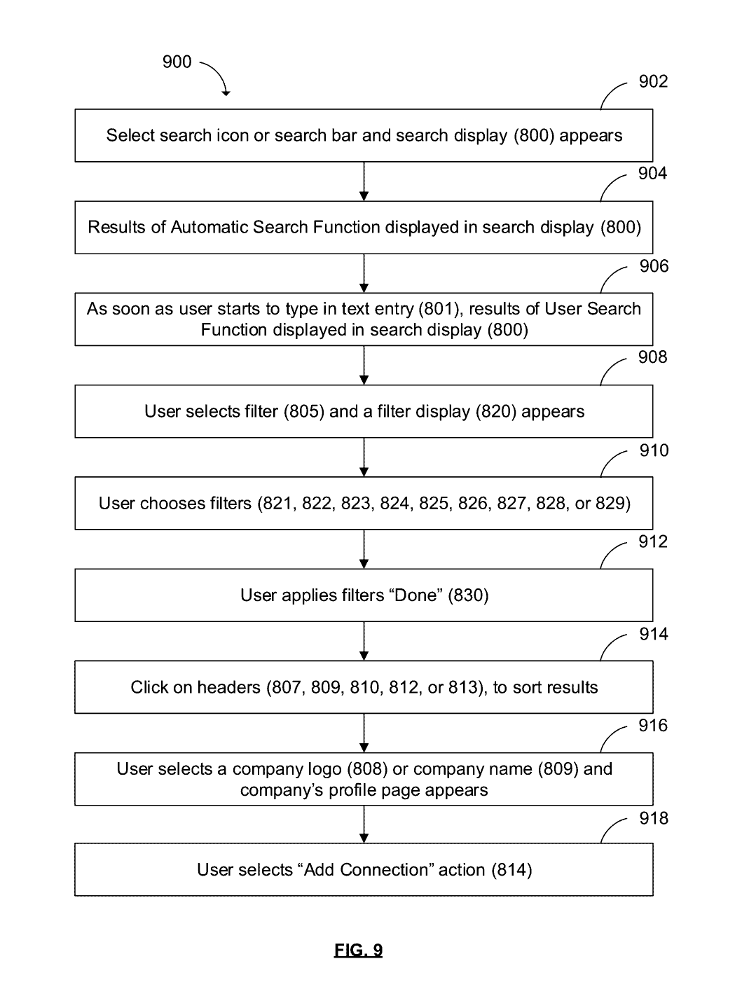

Referring to FIG. 6, illustrated therein is a flowchart showing the steps of the matching process, in accordance with an embodiment of the present disclosure. FIG. 6 illustrates the steps of the matching process performed by the match manager 60, referred to generally as 600. At step 602, the match manager 60 receives a user company identifier 103, candidate company identifiers 130, and at least one of a search term 110 and a search filter 120. At step 604, the match manager 60 retrieves the organization profile 21 and company rankings 140 associated with each of the user company identifier 103 and the candidate company identifier 130 from the database 20.

At step 606, the match manager 60 calculates a match rating 150 for the user company identifier 103 with each of the candidate company identifiers 130, based on the at least one of a search term 110 and a search filter 120, and the organization profiles 21 and the company rankings 140 from the database 20. At step 608, the match manager 60 submits the match rating 150 to the B2B System Engine 11.

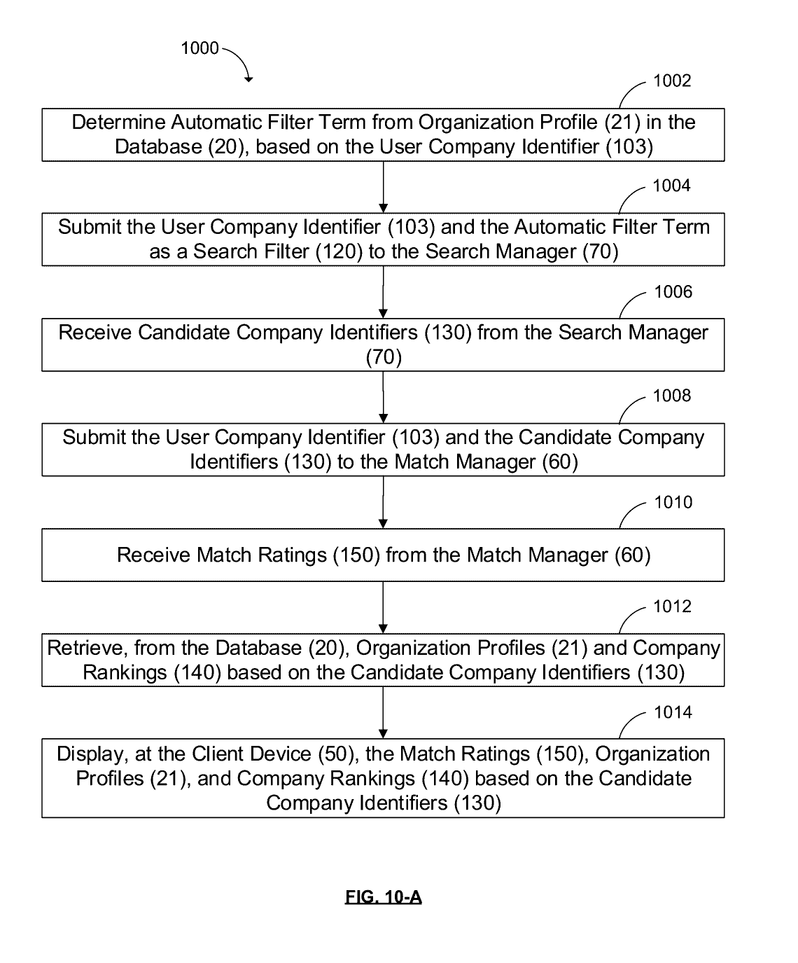

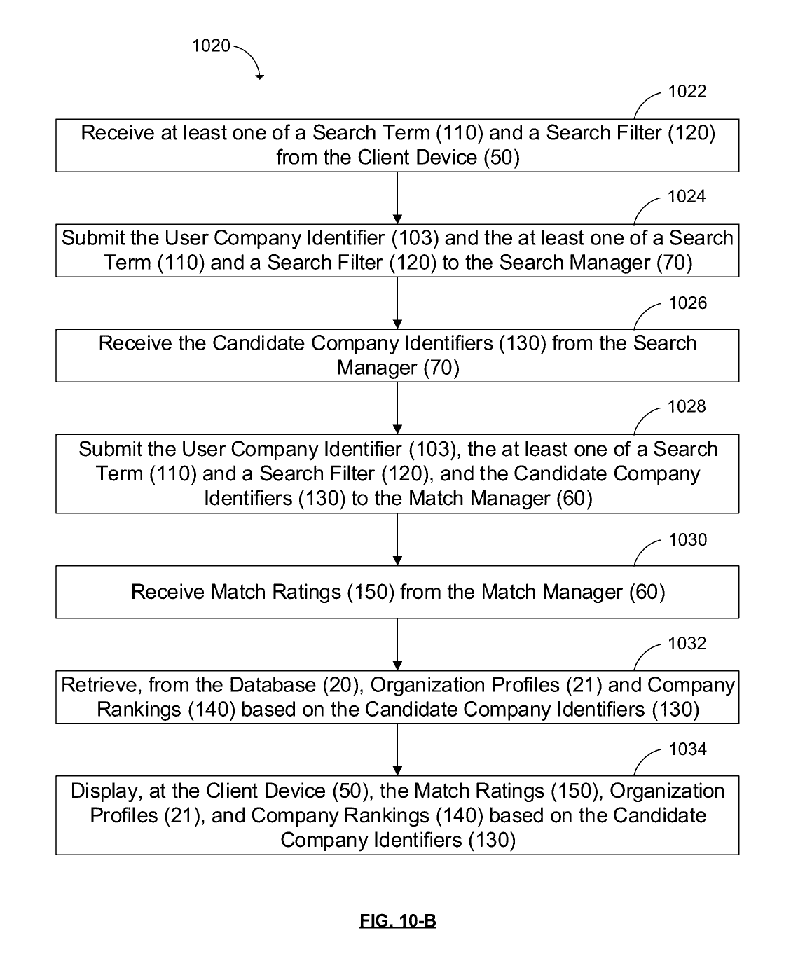

FIG. 7 shows a block diagram illustration of the search manager 70 used in the system 10 of FIG. 1, in accordance with at least one embodiment. The search manager 70 may receive a user company identifier 103 associated with a first organization profile 21 stored in the database 20 and locate other organization profiles 21 stored in the database 20 that the first organization profile 21 may connect with or contact. The other organization profiles 21 are associated with company identifiers, which may be referred to as candidate company identifiers 130.

In some embodiments, the searching process to locate candidate company identifiers 130 may be initiated by a user associated with the first profile 21 performing an active search. The example provided above, of a search for a company in a particular industry, is an active search.

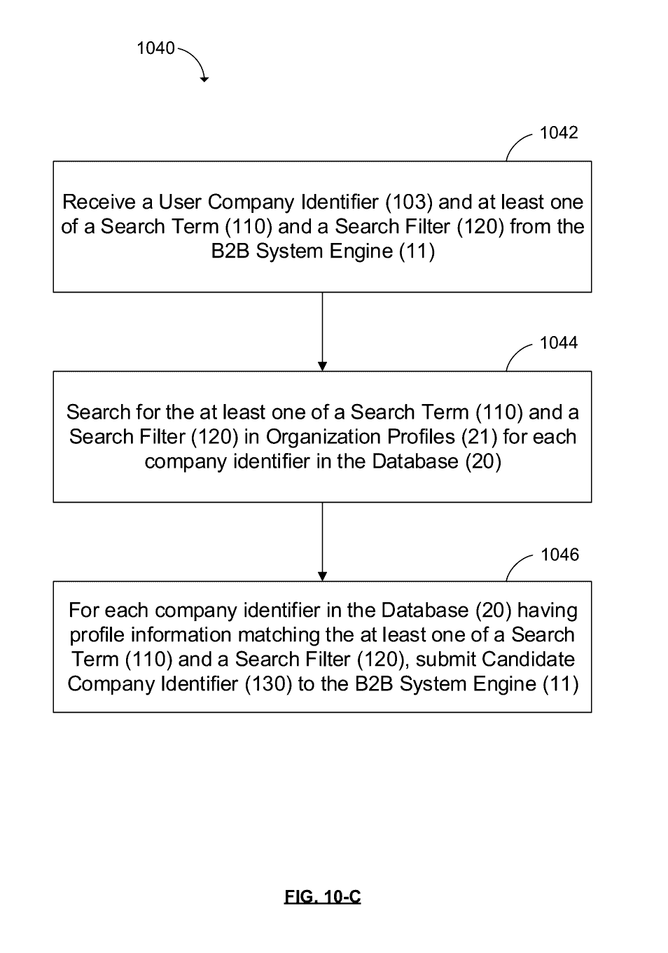

FIGS. 8-A and 8-B show screen captures of GUIs that can be displayed on a display of a client device 50 for a user to perform a search, in accordance with at least one embodiment. A search to find potential contacts, connections, or candidate companies, may be performed using keywords or filters, or both.

To perform a search based on keywords, a user at a client device 50 may enter keywords or characters in text entry box 801 of the search display 800 shown in FIG. 8-A. In some embodiments, the search display 800 may display 802 the company ranking 140 of the organization profile 21 that the user is associated with. In some embodiments, the subscription category of an organization profile 21 limits the potential connections, or companies to which they may connect with or contact. For example, the system 10 may permit a company having a lower subscription category to connect with other companies that have lower company rankings 140 (e.g. in the range of 0 to 50). The system 10 may permit a company having a higher subscription category to connect with any company (e.g. 0 to 100). The search display 800 may show such limits 803. In some embodiments, the search display 800 also provides a command button 804 to enable to user to modify the subscription category of the organization profile 21 from the search display 800.

In some embodiments, the search results, or candidate companies, may be displayed in a table format 806. The search results may include the name, logo, company ranking 140, location of company headquarters, industry, and sub-industry of the candidate company, and the match rating 150 of the user's company and the candidate company. The search results may further include any other appropriate information of an organization profile 21 stored in the database 20. The company logos shown in 808 allow users to visually recognize candidate companies. Company logos 23 or company names 22 can be selected to navigate to a webpage for the candidate company's profile 21.

The search results may also be sorted by selecting the header of the table 806. For example, to locate candidate companies with the highest match ratings 150, a user may select header 807 to sort the results in descending order. The company name 22 shown in 809 provides users with the full company name of the potential connection. To sort the candidate companies in alphabetical order, a user may select header 809. The location of company headquarters may be shown in 810. In some embodiments, a user may select header 810 to sort the location of candidate companies' headquarters in alphabetical order. For example, if search results include companies having headquarters in Vancouver, British Columbia; Edmonton, Alberta; and Toronto, Ontario, then these results may be sorted alphabetically as Edmonton, Toronto, and Vancouver, British Columbia. In some embodiments, a user may select header 810 to sort the candidate companies geographically. Geographical sorting may be determined by relative vicinity to the location of the user's company headquarters. If a company is located in Halifax, Nova Scotia, and search results include companies having headquarters in Vancouver, Edmonton, and Toronto, then these results may be sorted geographically as Toronto, Edmonton, and Vancouver. In some embodiments, the geographical sorting may be performed relative to the ISP location of the user, which may be different from the company headquarters.

The industry and the sub-industry of the candidate company may be shown in 812 and 813, respectively. Again, the results may be sorted in alphabetical order of industry or sub-industry by selecting headers 812 or 813. Further, any results may also be sorted in reverse order. Namely, any results that may be sorted in ascending order may also be sorted in descending order, and vice versa.

The search display 800 may also enable companies to perform actions such as message or connect with a candidate company. For example, selecting to message a candidate company from 814 may cause a message display to be displayed at the client device 50 for the user to compose a message to the candidate company. In another example, selecting to connect with a candidate company may cause a message to be displayed at the client device 50 for a user associated with the candidate company requesting acceptance of the connection.

The search display 800 may provide additional content 815. Such additional content include but is not limited to media clips, news, marketing, and how-to-tips. In some embodiments, such additional content may be related to the search results. In some embodiments, such additional content may be unrelated to the search results.

To perform a search based on filters, the user may select a filter command button 805 of the search display 800 to access the filter display 820 shown in FIG. 8-B. In one embodiment, filters may be applied to, but are not limited to, location 821, industry 822, sub-industry 823, company ranking 824, stock price 825, revenue 826, number of employees 827, company longevity (e.g., history) 828, and channel to market 829. In some embodiments, channel to market may indicate whether a company or business is a retailer, wholesaler, distributor, authorized dealer, or representative.

In some embodiments, the searching process to locate candidate company identifiers 130 may be initiated by the B2B System Engine 11. This search may be an automatic, or default, search that is performed when a user signs onto, or logs into, the system 10. This automatic search may be a feature of the system 10 to recommend, or encourage, or suggest new connections. The results of the automatic search may be initially displayed in the search display 800 prior to the user having entered characters or keywords in the text entry box 801. This automatic search may be performed based on the organization profile 21 stored in the database 20. Any appropriate information found in an organization profile 21 may be the basis of the automatic search. For example, the automatic search may be based on the company's location or industry.

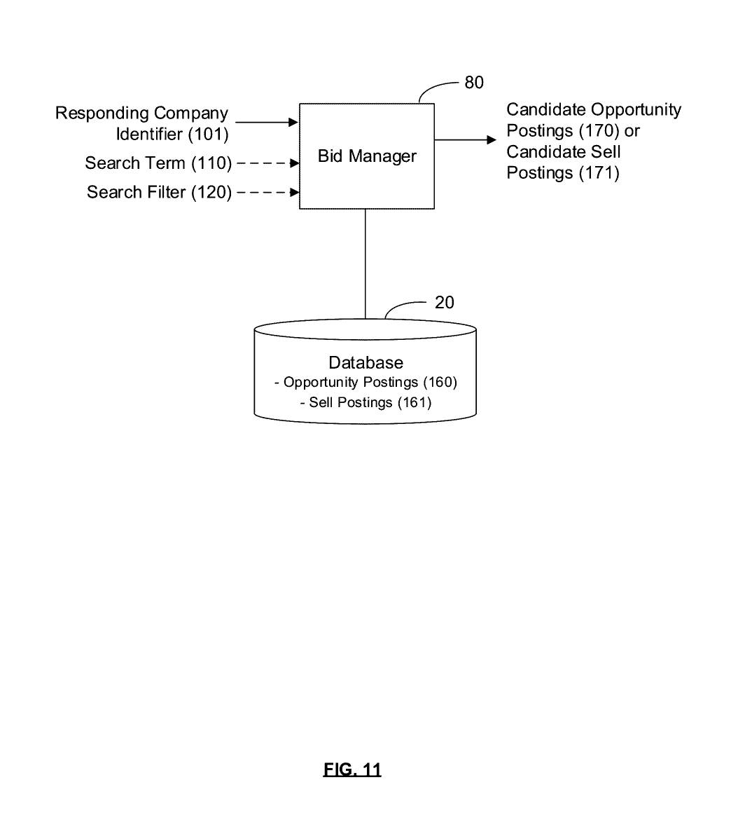

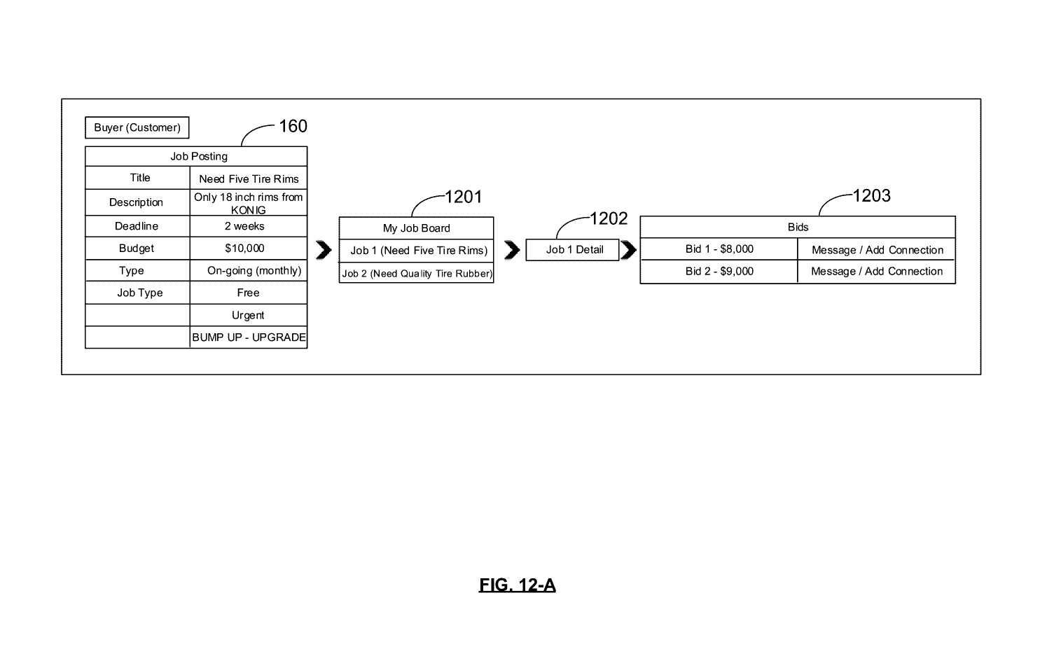

FIG. 9 illustrates the steps of a search performed by a user, referred to generally as 900. At step 902, the user selects a search icon or search bar within the B2B website or B2B application and the search display 800 appears. At step 904, the results of the automatic search are displayed in the search display 800. At step 906, the user may begin to type in the text entry box 801 and, in response, the results of a search based on the entry in the text entry box 801 are displayed.

At step 908, the user may select the filter command button 805 to access the filter display 820. At step 910, the user may choose the appropriate filters 821, 822, 823, 824, 825, 826, 827, 828, or 829. At step 912, the user clicks a “Done” command button 830 to apply the filters, and in response, the search results are updated with the filters applied. At step 914, a user may click on headers 807, 809, 810, 812, or 813 to sort the results. At step 916, a user may select a company logo 808 or a company name 809 to navigate to a webpage for the candidate company's profile. At step 918, a user may select an action 814 such as messaging a candidate company or connect with a candidate company.

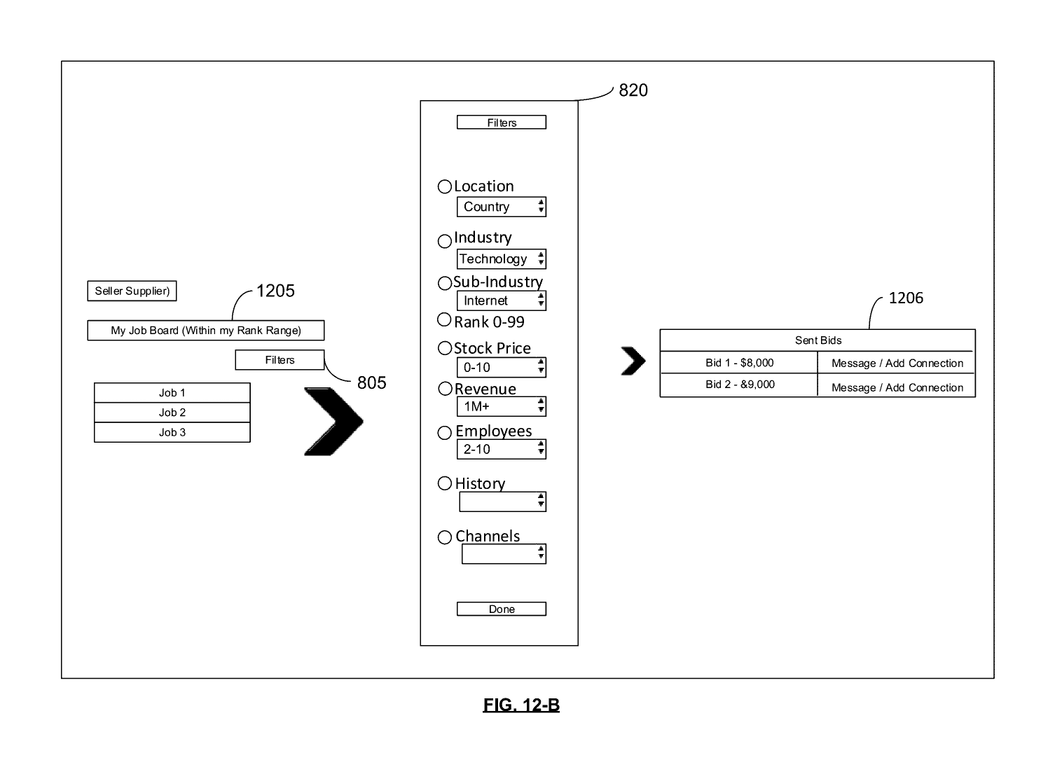

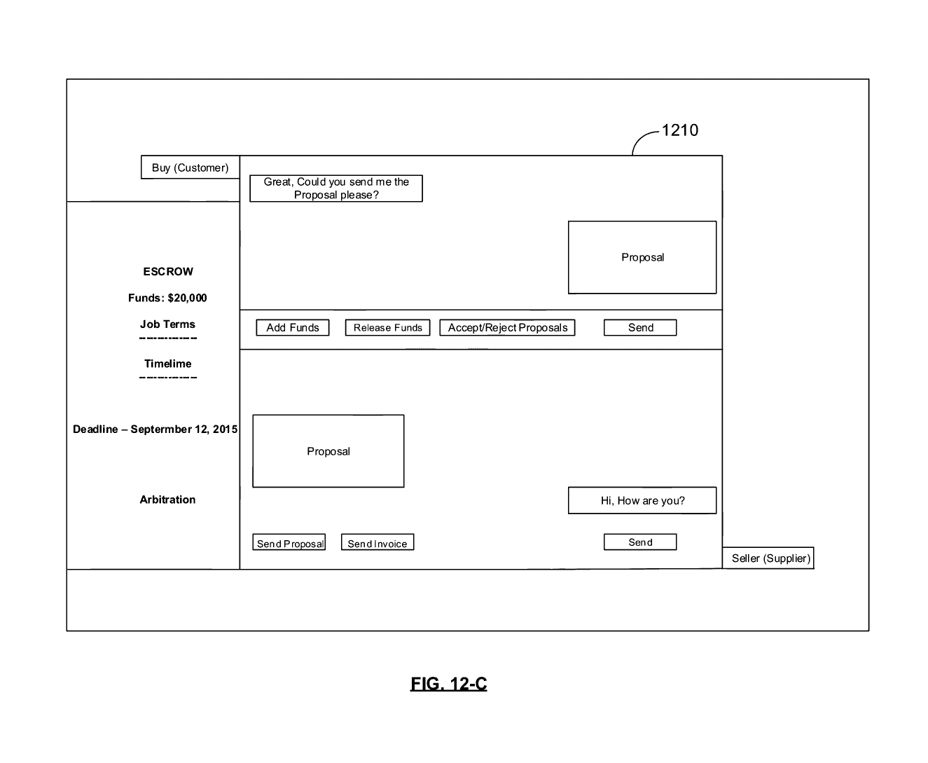

Referring to FIGS. 10-A to 10-C, illustrated therein are flowcharts showing the steps of the searching process, in accordance with an embodiment of the present disclosure. The searching process generally involves the B2B System Engine 11, the search manager 70, and the match manager 60.

FIG. 10-A illustrates the steps of the automatic search performed by the B2B System Engine 11, referred to generally as 1000. The automatic search may be initiated by a user associated with an organization profile 21 signing onto the system 10 at client device 50 with the user company identifier 103 and navigating to the search display 800. At step 1002, the B2B System Engine 11 determines an Automatic Filter Term from the organization profile 21 in the database 20 based on the user company identifier 103. For example, the B2B System Engine 11 may be configured to determine the Automatic Filter Term based on the company industry. At step 1004, the B2B System Engine 11 submits the user company identifier 103 and the Automatic Filter Term to the search manager 70.

At step 1006, the B2B System Engine 11 receives candidate company identifiers 130 from the search manager 70. Next, at step 1008, the B2B System Engine 11 submits the user company identifier 103 and candidate company identifiers 130 to the match manager 60, which carries out the matching process 600.

At step 1010, the B2B System Engine 11 receives match ratings 150 from the match manager 60. At step 1012, the B2B System Engine 11 retrieves, from the database 20, organization profiles 21 and company rankings 140 based on the candidate company identifiers 130. At step 1014, the B2B System Engine displays, at the client device 50, the match ratings 150, organization profiles 21, and company rankings 140 based on the candidate company identifiers 130. When the results are displayed the table format 806, match ratings 150 may be displayed in 807; company rankings 140 may be displayed in 811; and logos 23, company names 22, location, industry, and sub-industry of the organization profiles 21 may be displayed in 808, 809, 810, 812, and 813.

FIG. 10-B illustrates the steps of the user search process performed by the B2B System Engine 11, referred to generally as 1020. The user search process 1020 may be initiated by a user at a client device 50 entering a search term 110 in the text entry box 801 or a user applying filters 830, or both. At step 1022, the B2B System Engine 11 receives at least one of a search term 110 and a search filter 120 from the client device 50 of the user. At step 1024, the B2B System Engine 11 submits the user company identifier 103 of the user at the client device 50 and the at least one of a search term 110 and a search filter 120 to the search manager 70. Steps 1026 to steps 1034 of the user search are similar to steps 1006 to steps 1014 of the automatic search.

FIG. 10-C illustrates the steps of the search function performed by the search manager 70, referred to generally as 1040. At step 1042, the search manager 70 receives a user company identifier 103 and at least one of a search term 110 and a search filter 120 from the B2B System Engine 11. At step 1044, the search manager 70 searches each profile 21 stored in the database 20 for the search term 110 or the search filter 120. For each profile 21 that has information matching the search term 110 or the search filter 120, the search manager 70 submits that company identifier as a candidate company 130 to the B2B System Engine 11.

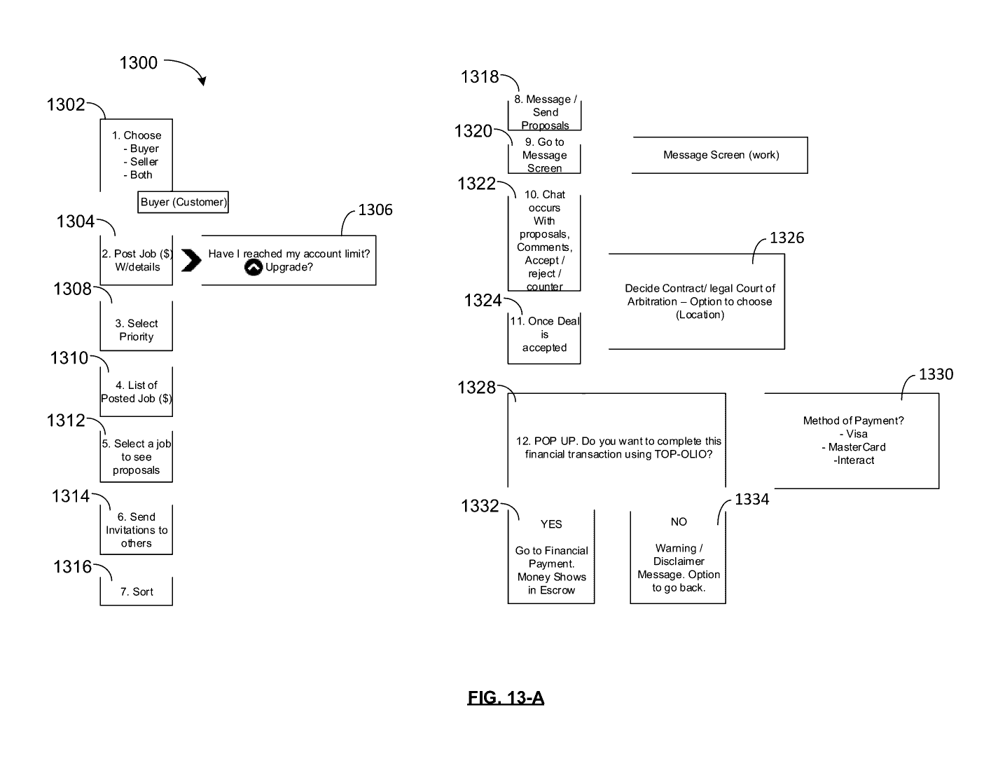

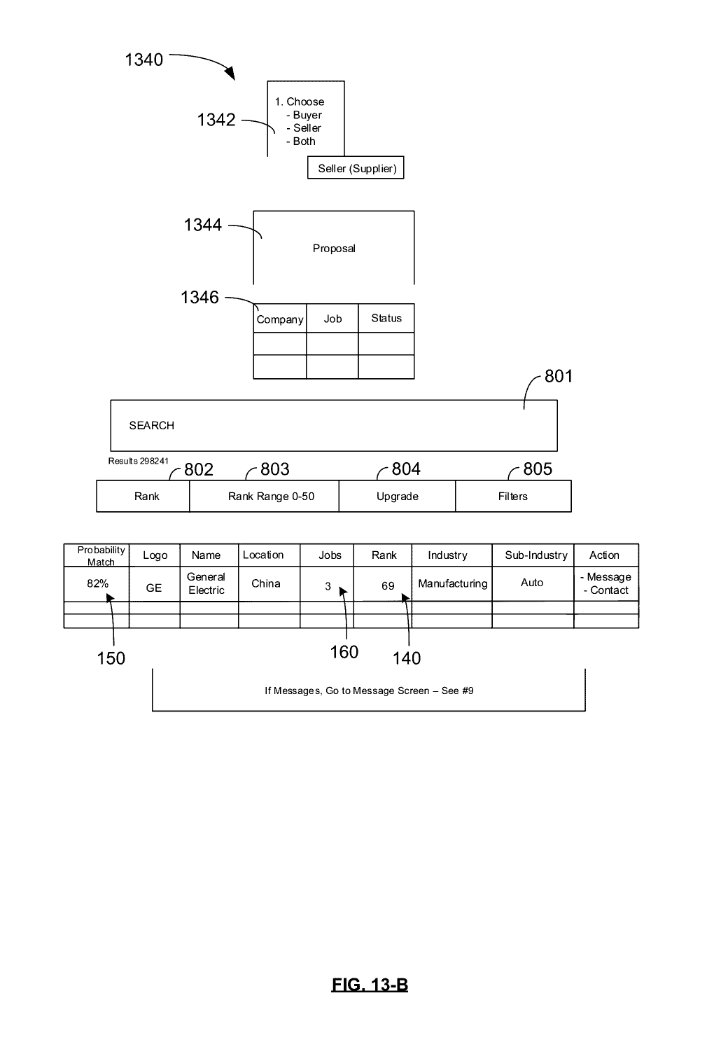

FIG. 11 shows a block diagram illustration of the bid manager 80 used in the system 10 of FIG. 1, in accordance with at least one embodiment. The bid manager 80 may receive a responding company identifier 101, associated with a first profile 21, stored in the database 20 and a request to locate opportunity postings 160 or seller postings 161 stored in the database 20 that the first profile 21 may pursue. The responding company identifier 101 is a company identifier 100. The opportunity postings 160 are associated with other organization profiles 21 that are different from the first profile 21 and may be referred to as candidate opportunity postings 170 of candidate company identifiers 130. The seller postings 161 are also associated with other organization profiles 21 that are different from the first profile 21 and may be referred to as candidate seller postings 171 of candidate company identifiers 130.

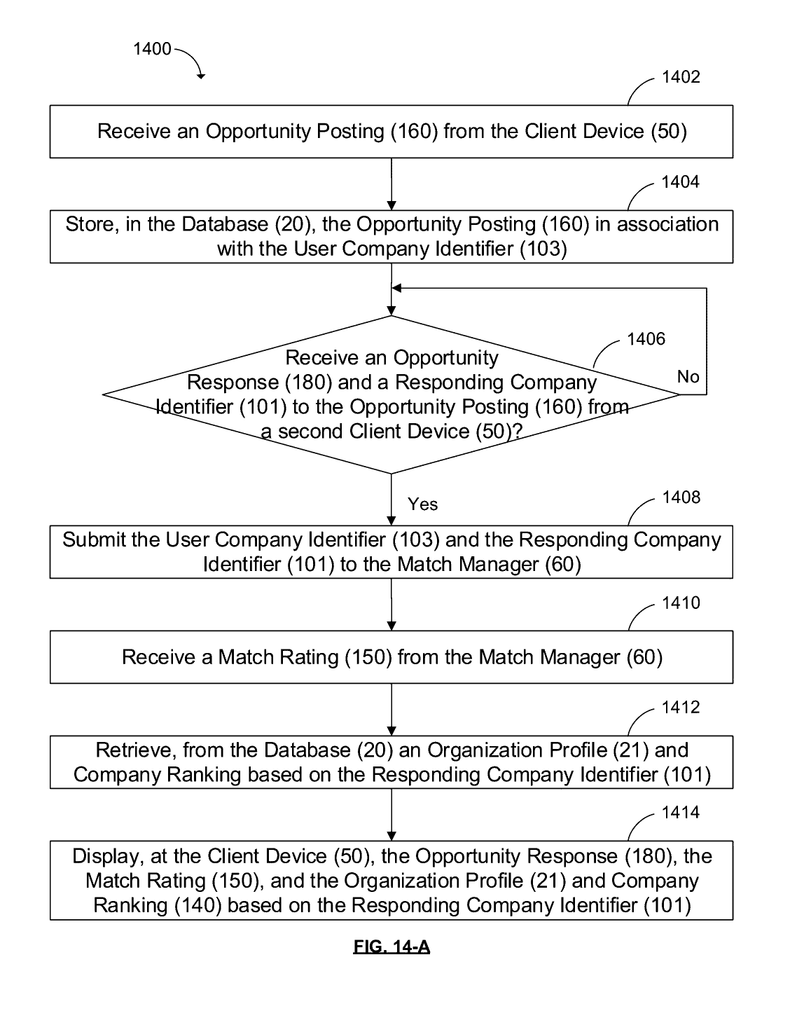

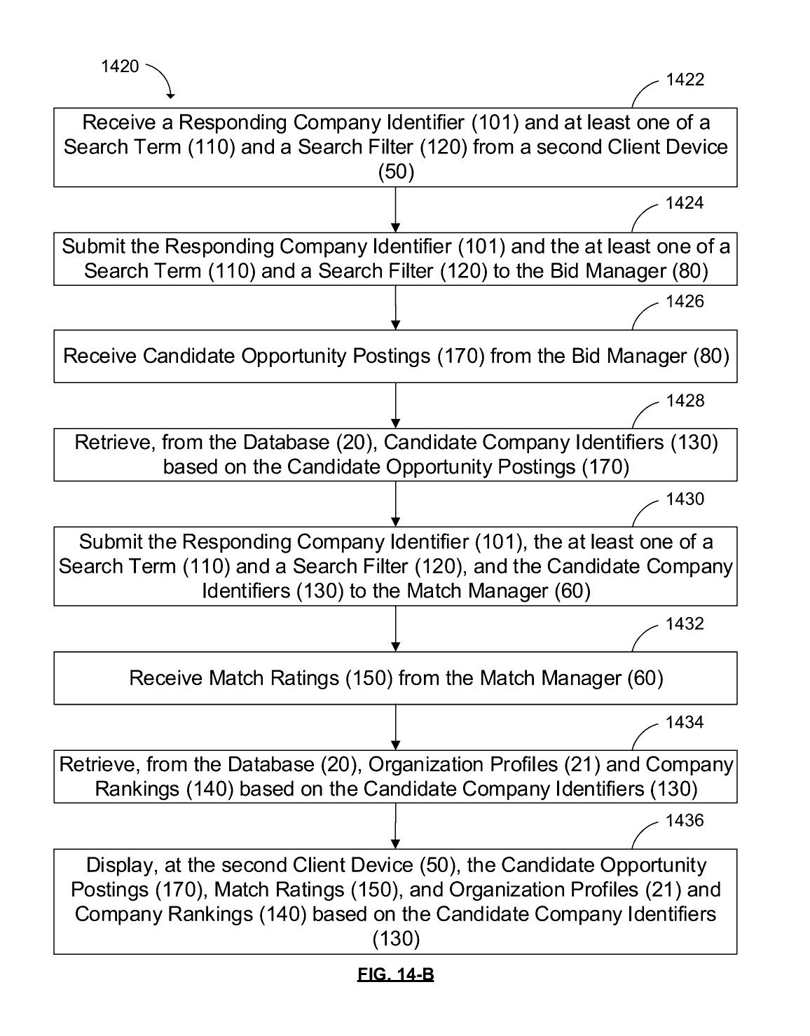

FIGS. 12-A to 12-C show screen captures of GUIs that can be displayed on a display of a client device 50 for a user to perform commercial transactions within the system 10, in accordance with at least one embodiment. The system 10 may enable each company to be a buyer, or customer, and create opportunity postings 160 stored in the database 20. The system 10 may provide each buyer with a buyer's job board 1201 listing the buyer's outstanding opportunity postings, or jobs, 160. For example, in 1201, a buyer may want to buy five tire rims and want to buy quality tire rubber. For each outstanding job, the system 10 provides a job details button 1202 which may be selected to view the job posting, or opportunity posting 160. An opportunity posting 160 may include a title, description of the job, deadline by which the job is required, budget for the job, recurrence of the job, type of job, and date of posting. The recurrence of the job may indicate whether the job is a one-time, or one instance, job, or whether the job is recurring on a regular basis such as weekly, monthly, or other suitable duration. The type of job relates to the priority of the opportunity posting 160, namely whether it is free, paid for, or urgent.

In some embodiments, the subscription category of an organization profile 21 limits the number of outstanding opportunity postings 160 that a buyer may have. In some embodiments, the buyer's job board 1201 also provides a command button to enable to user to modify the subscription category of the organization profile 21 so that additional opportunity postings 160 or higher priority opportunity postings 160 may be created.

The system 10 may also enable each company to be a seller, or supplier and as candidate companies, submit opportunity responses, or proposals, 180 to opportunity postings 160 stored in the database 20. In some embodiments, the system may enable buyers to invite specific sellers, such as companies that the buyer is connected to. The subscription category of an organization profile 21 may limit the number of invites that a buyer may send and the number of opportunity responses 180 that a seller may submit.

After candidate companies have submitted opportunity responses 180, a buyer may view opportunity responses 180 as shown in 1203. Although not shown, in some embodiments, the opportunity responses may be displayed with the match ratings 150. The buyer may perform actions such as message or connect with a candidate company. The buyer may also choose to accept or reject the opportunity response 180.

The system 10 may enable sellers to locate opportunity postings 160. The system 10 may provide each seller with a seller's job board 1205 listing candidate opportunity postings 170 that the seller may pursue. Opportunity postings 160 may be located using keyword searches or using filters, forming an opportunity request. To locate opportunity postings 160 using filters, the user may select a filter command button 805 of the seller's job board 1205 to access the filter display 820.

After submitting opportunity responses 180, a seller may view the opportunity responses 180 that they have submitted, as shown in 1206. Each opportunity response 180 may be associated with a status such as open, won, and lost. The seller may perform actions such as message or connect with a company that they have submitted an opportunity response 180 to.

In at least one embodiment, a bid-message screen 1210 shown in FIG. 12-C may enable buyers and sellers to send messages to one another. For example, the bid-message screen 1210 may display the buyer's comments and offer in the upper portion of the screen and the seller's comments and proposal 180 in the lower portion of the screen.

In addition, the bid-message screen 1210 may enable buyers and sellers to interact with one another to reach a deal. Actions that buyers may take include requesting, accepting, and rejecting proposals 180, and proposing counter offers. Actions that sellers may take include submitting and revoking proposals 180 and accepting and rejecting counter offers. A deal may be reached if a buyer accepts a seller's proposal 180 or if a seller accepts a buyer's counter offer. The system 10 may maintain a log, or record, or history of the buyer's and seller's actions.

The system 10 may also be configured to enable the seller and the buyer to complete a financial transaction after a deal is reached. The financial transaction may include holding funds, or job payment, in escrow. The system 10 may also be configured to enable the buyer and the seller to agree on, or acknowledge, the terms for job payment, or release of funds held in escrow. The system 10 may also be configured to transfer transaction disputes to a third-party arbitration body for resolution. The system 10 may be configured to accept any appropriate method of payment, including credit cards, electronic funds transfers, electronic checks, Paypal™, and other electronic payment methods. The system 10 may also be configured to enable the buyer and the seller to agree on, or acknowledge, the laws that will govern the transaction.

Opportunity postings 160 may be associated with different statuses. After a deal is reached for an opportunity posting 160, the opportunity posting 160 may become a committed opportunity. When an opportunity posting 160 becomes a committed opportunity, the bid manager 80 does not include the opportunity posting 160 in further searches. Thus, the system 10 will not receive additional opportunity responses 180 for the opportunity posting 160.

Sellers and buyers may acknowledge, or indicate in the system 10, when a committed opportunity has completed. In some embodiments, acknowledgement is required from either the seller or buyer, or both. After a job has completed, the system 10 may invite the buyer and the seller to submit an endorsement 28 of the other party. The history of opportunity postings, opportunity responses, committed opportunities, and completed transactions, may be used to determine the transactions criterion of the internal company ranking 141. As well, the quality and number of endorsements received and submitted may be used to determine the endorsements criterion of the internal company ranking 141. Accordingly, the bid manager 80 may act as an internal ranking support manager 33.

FIGS. 13-A and 13-B illustrate the steps of opportunity posting and opportunity responding for users, referred to generally as 1300 and 1340. At step 1302, the user indicates that they are acting as a buyer, or customer. At step 1304, the buyer may choose to create an opportunity posting 160. At step 1306, the buyer may upgrade the subscription category in order to create an opportunity posting 160. At step 1308, the buyer may select a priority to be associated with the opportunity posting 160. At step 1310, the buyer may view a list of their opportunity postings 160. At step 1312, the buyer may select an opportunity posting 160 to see the opportunity response 180 that have been submitted. At step 1314, the buyer may send an invite to others to submit opportunity responses 180 to an opportunity posting 160. At step 1316, the buyer may sort the opportunity responses 180 that have been received. At step 1318, the buyer may message companies that have submitted opportunity responses 180. At step 1320, the buyer may view the bid-message screen 1210. At step 1322, the buyer may perform actions such as accept or reject a proposal, or make a counter offer. At step 1324, a deal may be reached. At step 1326, the buyer may select the laws that will govern the transaction. At step 1328, the buyer may select whether to complete the transaction within the system 10. If the buyer chooses to complete the transaction within the system 10, the buyer proceeds to step 1330 to make payment and the funds are held in escrow in step 1332. If the buyer chooses not to complete the transaction within the system 10, a disclaimer may appear 1334.

At step 1342, the user indicates that they are acting as a seller, or supplier. At step 1344, the seller may select “My Proposals” to view their submitted opportunity responses 180. At step 1346, the seller's submitted opportunity response 180 may appear with an indication of their status.

The seller may further search for opportunity postings 160 using a display similar to the search display 800. The seller may enter keywords in a text entry box 801. The search results may be displayed in a table format similar to 806 displaying the match rating 150, company ranking 140, and profile information. The search results may further display the total number of opportunity postings 160 that a buyer may have. With this information, a seller may be more strategic about which opportunity postings 160 to respond to.

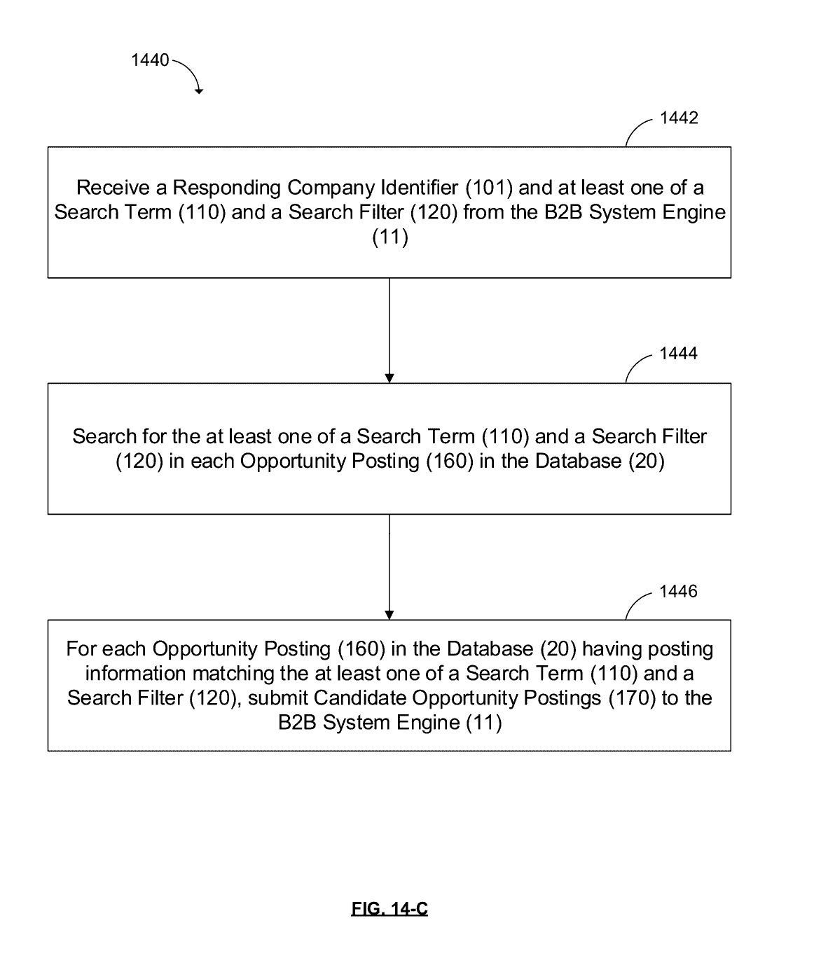

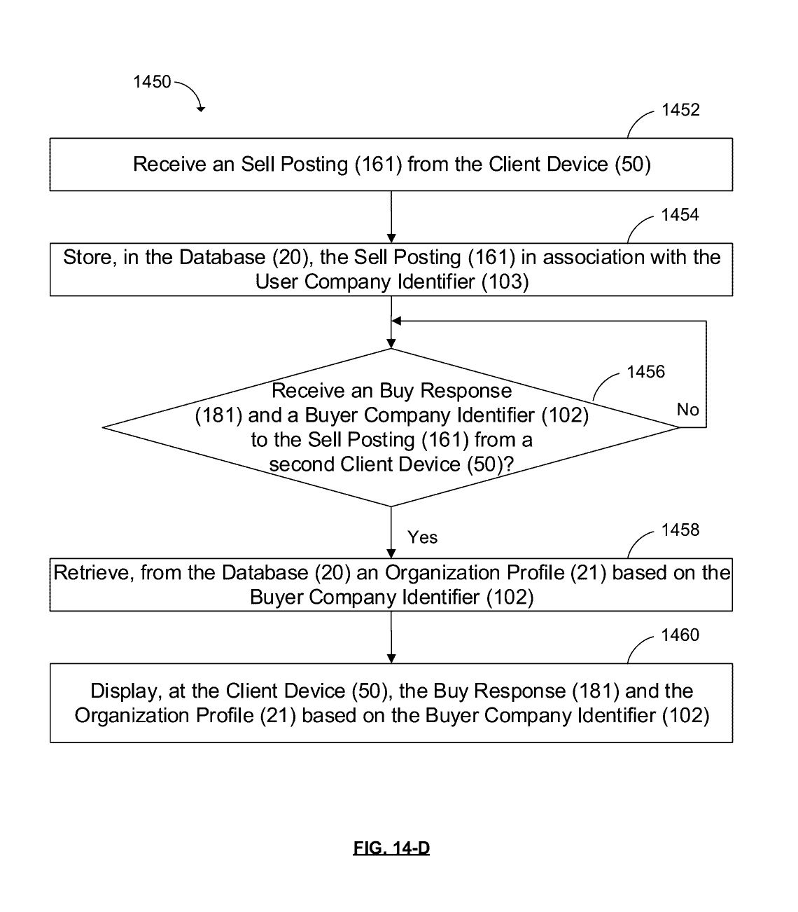

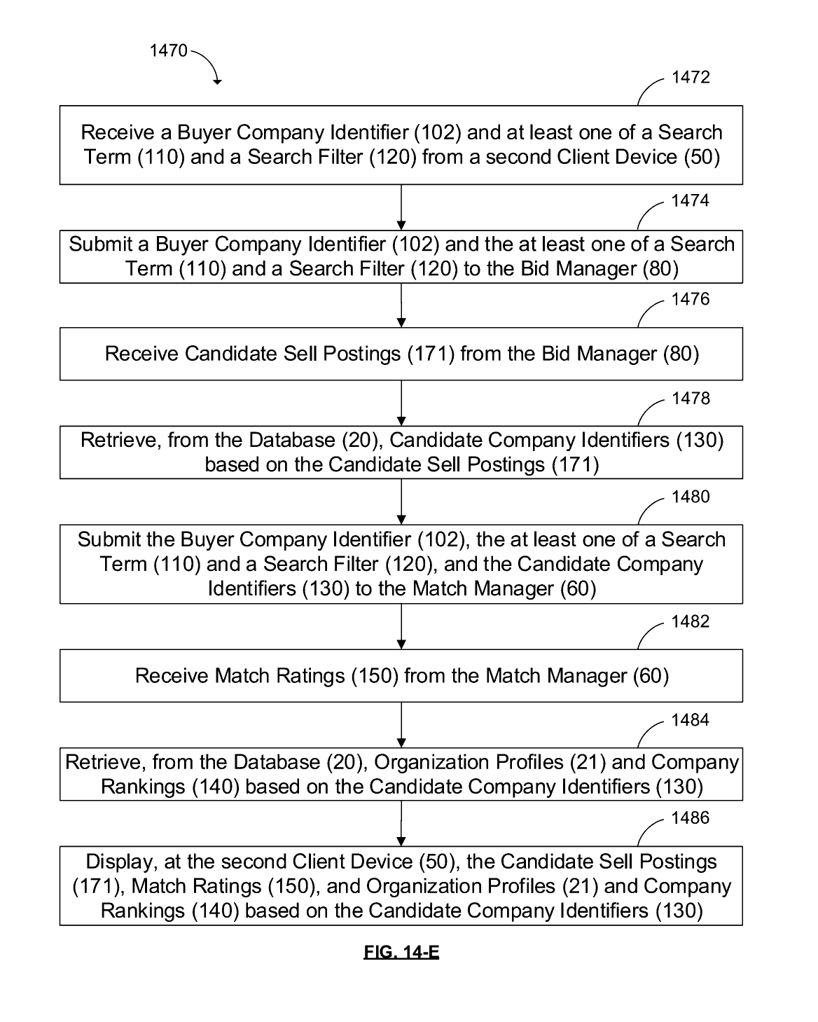

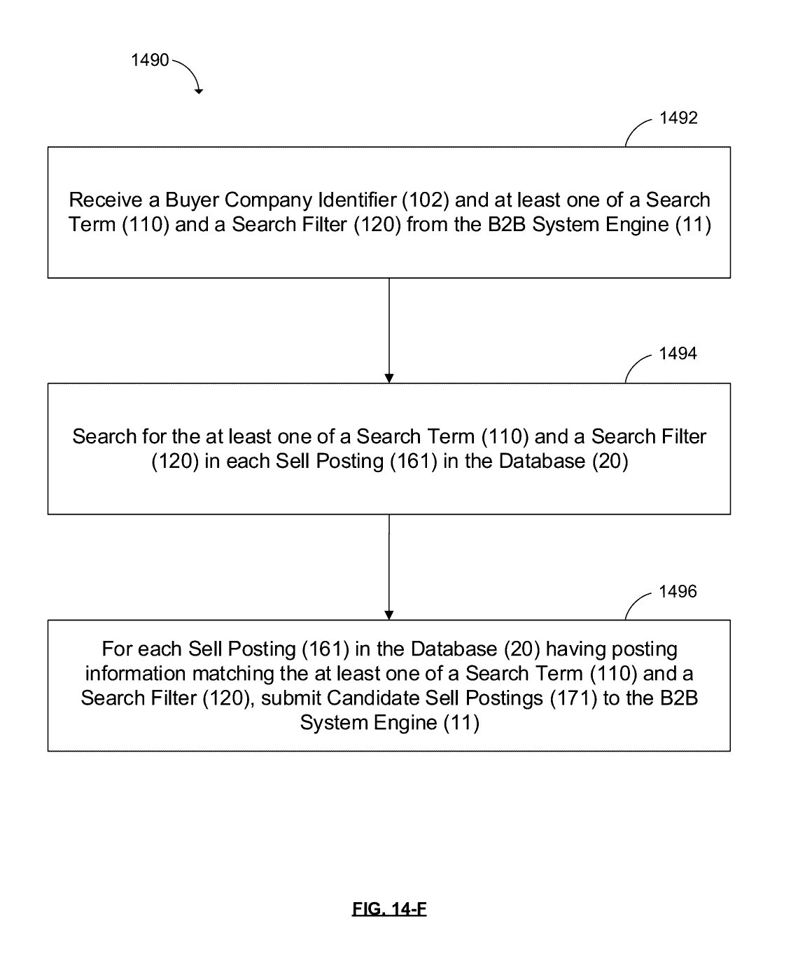

Referring to FIGS. 14-A to 14-C, illustrated therein are flowcharts showing the steps of the commercial transaction process for opportunity postings and responses, in accordance with an embodiment of the present disclosure. The opportunity posting and response process generally involves the B2B System Engine 11, the bid manager 80, and the match manager 60.

FIG. 14-A illustrates the steps of the opportunity posting process performed by the B2B System Engine 11, referred to generally as 1400. The opportunity posting process may be initiated by a user associated with an organization profile 21 signing onto the system 10 at client device 50 with the user company identifier 103 and navigating to their buyer's job board 1201. At step 1402, the B2B System Engine 11 receives an opportunity posting 160 from the client device 50 of the user. At step 1404, the B2B System Engine 11 stores, in the database 20, the opportunity posting 160 in association with the user company identifier 103. At step 1406, the B2B System Engine 11 may receive an opportunity response 180 and a responding company identifier 101 to the opportunity posting 160 from a second client device 50. At step 1408, the B2B System Engine 11 submits the user company identifier 103 and the responding company identifier 101 to the match manager 60, which carries out the matching process 600, wherein the responding company identifier 101 is submitted to the match manager 60 as the candidate company identifier 130 in FIG. 5.

At step 1410, the B2B System Engine 11 receives match ratings 150 from the match manager 60. At step 1412, the B2B System Engine 11 retrieves, from the database 20, an organization profile 21 and company ranking 140 based on the responding company identifier 101. At step 1414, the B2B System Engine displays, at the client device 50, the opportunity response 180, the match rating 150, profile 21, and company ranking 140 based on the responding company identifier 101.

FIG. 14-B illustrates the steps of the opportunity response process performed by the B2B System Engine 11, referred to generally as 1420. The opportunity response process may be initiated by a user associated with an organization profile 21 signing onto the system 10 at a second client device 50 with a responding company identifier 101 and navigating to their seller's job board 1205. At step 1422, the B2B System Engine 11 receives a responding company identifier 101 and at least one of a search term 110 and a search filter 120 from the second client device 50. At step 1424, the B2B System Engine 11 submits the responding company identifier 101 and the at least one search term 110 and a search filter 120 to the bid manager 80.

At step 1426, the B2B System Engine 11 receives candidate opportunity postings 170 from the bid manager 80. Next, at step 1428, the B2B System Engine 11 retrieves, from the database 20, candidate company identifiers 130 based on the candidate opportunity postings 170. At step 1430, the B2B System Engine 11 submits the responding company identifier 101 and candidate company identifiers 130 to the match manager 60, which carries out the matching process 600, wherein the responding company identifier 101 is submitted to the match manager 60 as the user company identifier 103 in FIG. 5.

At step 1432, the B2B System Engine 11 receives match ratings 150 from the match manager 60. At step 1434, the B2B System Engine 11 retrieves, from the database 20, organization profiles 21 and company rankings 140 based on the candidate company identifiers 130. At step 1436, the B2B System Engine displays, at the second client device 50, the candidate opportunity postings 170, the match ratings 150, organization profiles 21, and company rankings 140 based on the candidate company identifiers 130, as shown in FIG. 13-B.

FIG. 14-C illustrates the steps of the opportunity response function performed by the bid manager 80, referred to generally as 1440. At step 1442, the bid manager 80 receives a responding company identifier 101 of the user and at least one of a search term 110 and a search filter 120 from the B2B System Engine 11. At step 1444, the bid manager 80 searches each opportunity posting 160 stored in the database 20 for the search term 110 or the search filter 120. For each opportunity posting 160 that has information matching the search term 110 or the search filter 120, the bid manager 80 submits that opportunity posting 160 as a candidate opportunity posting 170 to the B2B System Engine 11.

Referring to FIGS. 14-D to 14-F, illustrated therein are flowcharts showing the steps of the commercial transaction process for selling and buying, in accordance with an embodiment of the present disclosure. The sell and buy process generally involves the B2B System Engine 11, the bid manager 80, and the match manager 60.

FIG. 14-D illustrates the steps of the sell process performed by the B2B System Engine 11, referred to generally as 1450. The sell process may be initiated by a user associated with an organization profile 21 signing onto the system 10 at client device 50 with the user company identifier 103 and navigating to their seller's job board 1205. At step 1452, the B2B System Engine 11 receives a sell posting 161 from the client device 50 of the user. At step 1454, the B2B System Engine 11 stores, in the database 20, the sell posting 161 in association with the user company identifier 103. At step 1456, the B2B System Engine 11 may receive a buy response 181 and a buyer company identifier 102 to the sell posting 160 from a second client device 50. The buyer company identifier 102 is a company identifier 100. At step 1458, the B2B System Engine 11 retrieves, from the database 20, an organization profile 21 based on the buyer company identifier 102. At step 1460, the B2B System Engine displays, at the client device 50, the buy response 181 and the organization profile 21 based on the buyer company identifier 102.

FIG. 14-E illustrates the steps of the buy process performed by the B2B System Engine 11, referred to generally as 1470. The buy process may be initiated by a user associated with an organization profile 21 signing onto the system 10 at a second client device 50 with a buyer company identifier 102 and navigating to their buyer's job board 1201. At step 1472, the B2B System Engine 11 receives a buyer company identifier 102 and at least one of a search term 110 and a search filter 120 from the second client device 50. At step 1474, the B2B System Engine 11 submits the buyer company identifier 102 and the at least one search term 110 and a search filter 120 to the bid manager 80, wherein the buyer company identifier 102 is submitted to the bid manager 80 as the responding company identifier 101 in FIG. 11.

At step 1476, the B2B System Engine 11 receives candidate sell postings 171 from the bid manager 80. Next, at step 1478, the B2B System Engine 11 retrieves, from the database 20, candidate company identifiers 130 based on the candidate sell postings 171. At step 1480, the B2B System Engine 11 submits the buyer company identifier 102, the at least one of a search term 110 and a search filter 120, and the candidate company identifiers 130 to the match manager 60, which carries out the matching process 600, wherein the buyer company identifier 102 is submitted to the match manager 60 as the user company identifier 103 in FIG. 5.

At step 1482, the B2B System Engine 11 receives match ratings 150 from the match manager 60. At step 1484, the B2B System Engine 11 retrieves, from the database 20, organization profiles 21 and company rankings 140 based on the candidate company identifiers 130. At step 1486, the B2B System Engine displays, at the second client device 50, the candidate sell postings 171, the match ratings 150, organization profiles 21, and company rankings 140 based on the candidate company identifiers 130.

FIG. 14-C illustrates the steps of the buy process performed by the bid manager 80, referred to generally as 1490. At step 1492, the bid manager 80 receives a buyer company identifier 102 of the user 101 and at least one of a search term 110 and a search filter 120 from the B2B System Engine 11. At step 1494, the bid manager 80 searches each sell posting 161 stored in the database 20 for the search term 110 or the search filter 120. For each sell posting 161 that has information matching the search term 110 or the search filter 120, the bid manager 80 submits that sell posting 161 as a candidate sell posting 171 to the B2B System Engine 11.

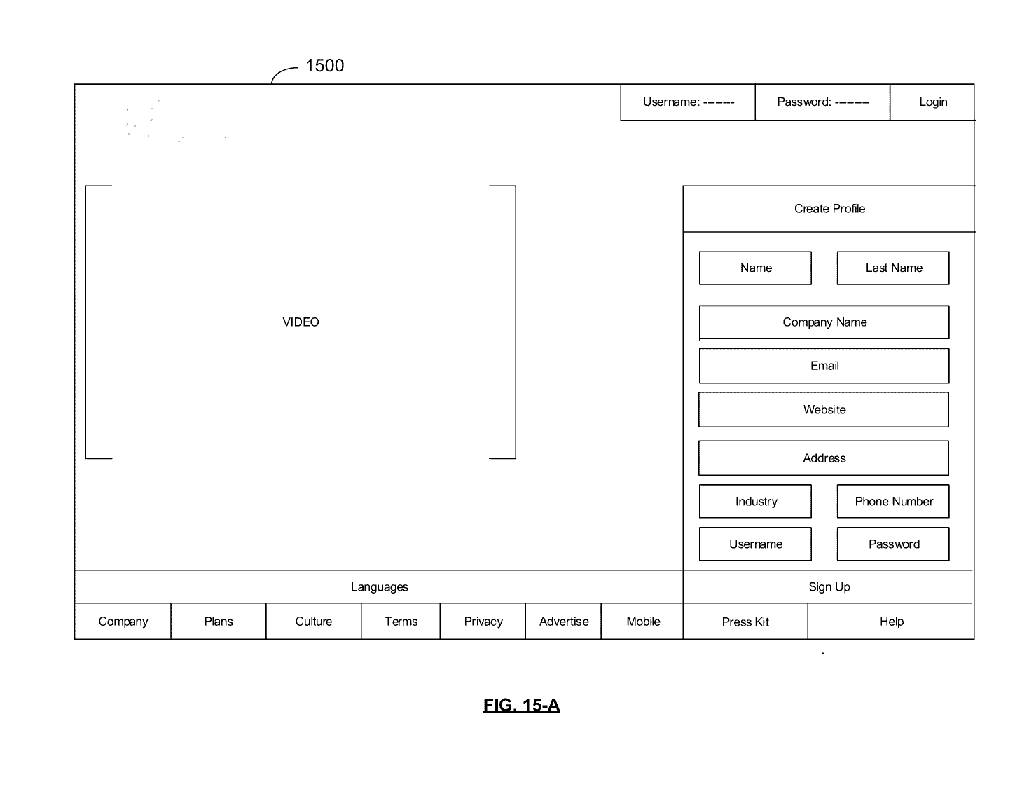

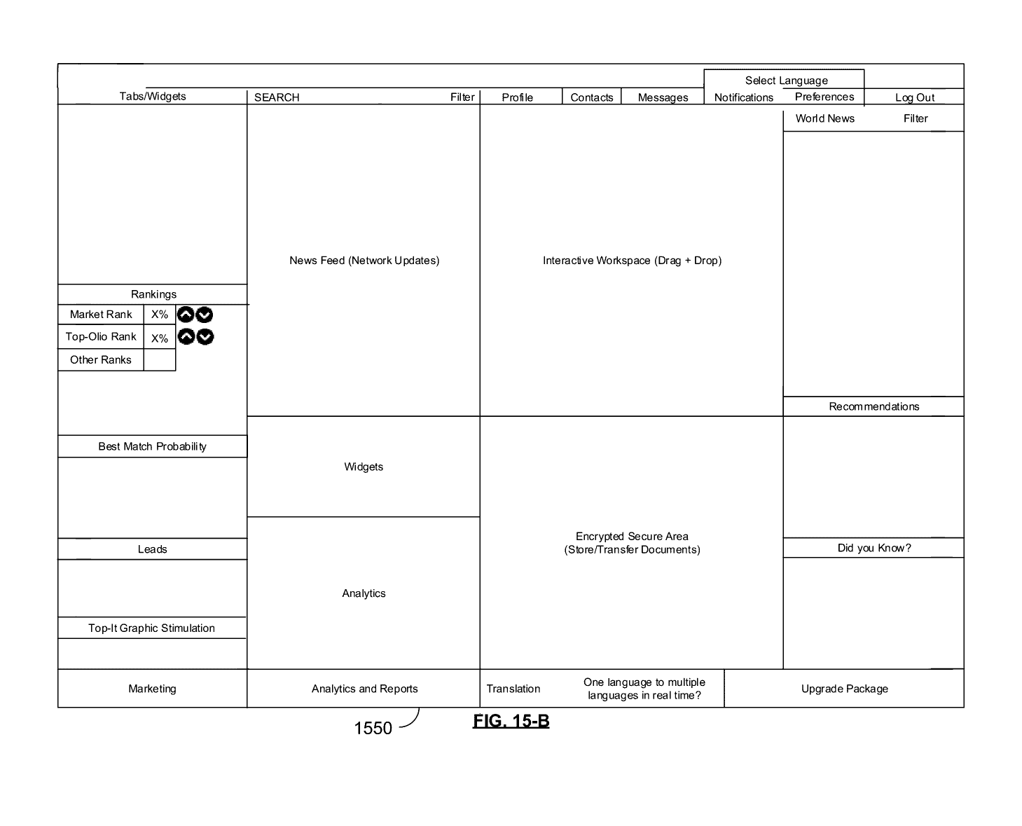

FIGS. 15-A and 15-B show screen captures of GUIs that can be displayed on a display of a client device 50 for a user to sign-on and navigate the system 10, in accordance with at least one embodiment. The system 10 may display a welcome page 1500 as shown in FIG. 15-A. The welcome page 1500 may include a video that introduces the platform. The welcome page 1500 may also enable users to join, or sign up, by creating an organization profile 21 and selecting a subscription category. After creating an organization profile 21 from the welcome page 1500, users may further edit the organization profile 21 that they are associated with from the GUI 12 shown in FIG. 2.

The welcome page 1500 may enable users that are already associated with an organization profile 21 stored in the database 20 to sign on to the system 10. After a user signs on to the system 10, the system 10 may display a corporate dashboard page as shown in FIG. 15-B. Accordingly, a user may sign off, or log out, of the system from the corporate dashboard page 1550. The corporate dashboard page 1550 may provide a search bar and filter command button 805 which may display the search display 800 and the filter display 820. The corporate dashboard page 1550 may also enable users to navigate to a profile page, such as GUI 12 shown in FIG. 2, to edit the organization profile 21 that they are associated with. Although not shown, the corporate dashboard page may also display a user's status (e.g., department or position) with the organization profile 21 that they are associated with. The corporate dashboard page 1550 may also enable users to select from various languages. The corporate dashboard page 1550 may enable users to obtain help, view frequently asked questions, or access instructional information or modules about using the system 10. Such information may be provided in any appropriate form such as text, video, or audio.

The corporate dashboard page 1550 may provide access to messages and contacts, or connections. In some embodiments, the system 10 may automatically translate of messages according to each profile's language settings. The skilled person in the art will recognize that messages may be sent to multiple other users. Accordingly, multiple language translations may be provided simultaneously.

The corporate dashboard page 1550 may display the company rankings 140 including the internal company ranking 141 and the external company ranking 142. The corporate dashboard page 1550 may also recommend connections by displaying a best match. That is, the system 10 may perform the automatic search and display an organization profile 21 with the highest match rating 150 as the “best match”. The corporate dashboard page 1550 may also display profile completion status 29. The corporate dashboard page 1550 may also display a graphical simulation to provide a visual, time-wise, representation of past, current, and projected company rankings. The graphical simulation may provide projected company rankings to assist users in assessing growth opportunities.

The corporate dashboard page 1550 may display news, advertisements, and information about contacts, including opportunity postings 160 that a contact may create. Such advertisements may be provided by contacts. In some embodiments, companies may advertise to contacts within the system 10 on a “pay per click” basis or “pay per advertisement” basis (e.g., banner or video). Companies may establish or set a budget for advertising. In some embodiments, the additional marketing structures may be provided to advertise to companies based on company rankings 140. Namely, standard marketing may permit companies to advertise to companies within a similar company ranking 140 range. Premium marketing may permit companies to advertise to companies with higher company rankings 140. A company's marketing or advertisements within the system may be used to determine the marketing criterion of the internal company ranking 141.

The corporate dashboard page 1550 may also provide a workspace for users to drag and drop widgets to perform other actions such as tracking projects, to do lists, create a calendar, instant messaging, reminders, updates, and business templates. The corporate dashboard 1550 may also provide a highly secure area to transfer files amongst users associated with the same profile 21, or amongst users associated with different organization profiles 21. The system 10 may also provide analytics, presented in reports shown on the corporate dashboard page 1550. Such analytics may be related to demographics, environmental issues, politics, economy, social issues, technology, geographical trends, and financial issues. Such analytics may be provided by external ranking support managers 34 using information external to the system 10. In some embodiments, the subscription category of an organization profile 21 may limit access to such analytics.

The corporate dashboard page 1550 may further display general information such as news and trends. The general information may be filtered to display information appropriate to the user, such as geography, industry, and type of news.

A skilled person will understand that the system 10 may provide other pages with information relevant to particular users. That is, pages provide any may be customized to provide any combination of information, depending on a user's status (e.g., department or position) with the organization profile 21 that they are associated with. For example, the system 10 may provide a particular dashboard directed to sales or marketing personnel. Such a sales or marketing dashboard may provide more information about customers and target industries. In another example, the system 10 may provide an executive dashboard page that offers a high level overview of global business performance of an organization profile 21. An executive dashboard page may provide financial information including revenue and expense, information about customers, and information about different business units, branches, departments, or business segments, or any combination of such. The executive dashboard page may also show a status bar which summarizes the status of ongoing projects, their title, description, and location. The executive dashboard may also enable users to invite other users associated with the same profile 21 to join a particular project. The executive dashboard may also provide an interactive global map to show the location of ongoing projects and include indicators of the project status.

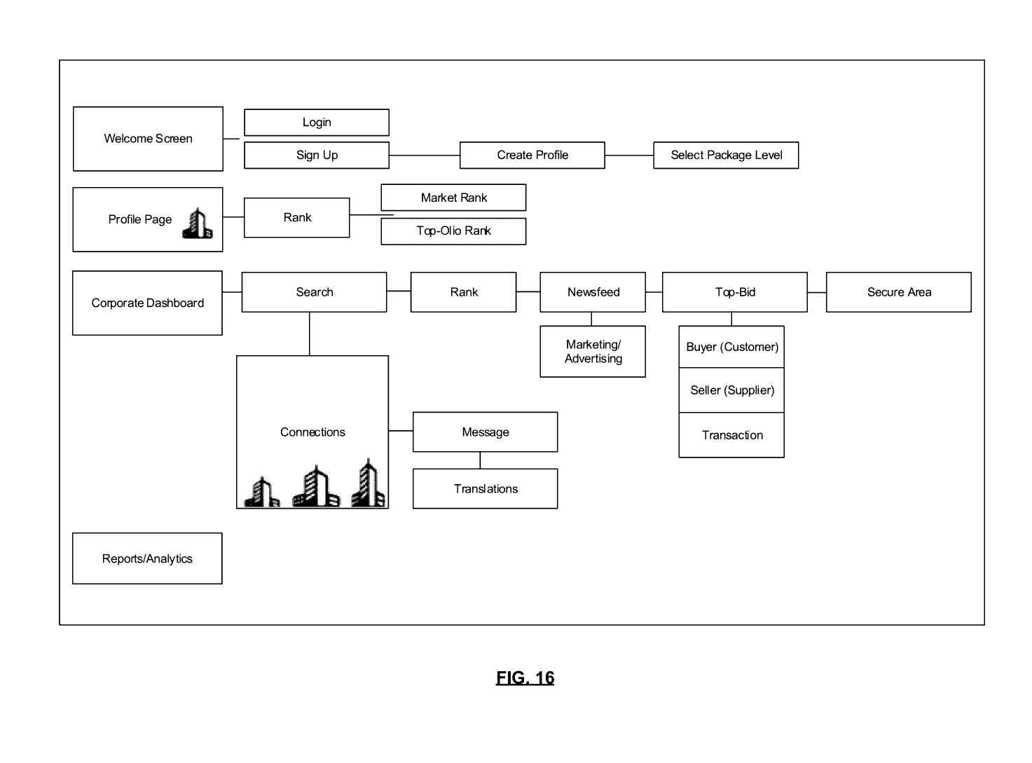

Referring to FIG. 16, illustrated therein are functions of a system 10, in accordance with an embodiment of the present disclosure. Generally, a user may first view the welcome page 1500. From the welcome page 1500 a user may sign-up, create an organization profile 21, and select a subscription category (shown as package level).

For each profile 21 stored in the database 20, the system 10 determines a company ranking 140 for the organization profile 21. The company ranking 140 may include an external company ranking 142 (shown as Market Rank) or an internal company ranking 141 (shown as Top-Olio™ Rank).

If a user has previously signed-up, created an organization profile 21, and selected a subscription category, the user may simply login, or sign-on to the system 10 from the welcome page 1500 and view the corporate dashboard 1550 for that profile 21. From the corporate dashboard 1550, a user may perform a search 900 for other organizations, companies, or business, (e.g. other organization profiles 21), to connect with or contact. Companies may contact one another by sending messages, which may be automatically translated.

From the corporate dashboard 1550, a user may view their company ranking 140 and newsfeed. In some embodiments, the newsfeed is based on a company's connections, particularly marketing and advertisements from connections. From the corporate dashboard 1550, a user may also securely transfer files to other users and access reports and analytics.

From the corporate dashboard 1550, a user may also perform commercial transactions. As a buyer, companies may create opportunity postings 160, receive opportunity responses 180 to their opportunity postings 160, track the status of jobs, seek sell postings 161, and submit buy responses 181 to sell postings 161. As a seller, companies may seek opportunity postings 160, submit opportunity responses 180 to opportunity postings 160, track the status of jobs, create sell postings 161, and receive buy response 181 to their sell postings 161.

1. A computer-implemented method of providing business-to-business interaction, the method comprising:
in a system configured to host a webpage, the system comprising at least one processor and a memory, storing on a storage device, a plurality of organization profiles and a plurality of user accounts, each organization profile being associated with at least one user account, each organization profile comprising information about a corresponding organization received from a client device linked to a user account associated with that organization profile;
determining a ranking for each of a first organization profile and a second organization profile; and
displaying, at a first client device linked to a user account associated with the first organization profile, a first graphical user interface comprising the ranking for the second organization profile and the second organization profile.

2. The method of claim 1, wherein:
the step of determining a ranking for each of a first organization profile and a second organization profile further comprises determining a match rating between the first organization profile and the second organization profile using the first organization profile, the second organization profile, and the rankings for the first organization profile and the second organization profile; and
the first graphical user interface further comprises the match rating.

3. The method of claim 1 further comprising:
receiving an electronic message for the second organization profile from the first client device; and
displaying at a second client device linked to a user account associated with the second organization profile, a messaging graphical user interface comprising the first organization profile, the ranking for the first organization profile, and the electronic message.

4. The method of claim 1, wherein each user account is associated with one organization profile.

5. The method of claim 2, wherein:
the second organization profile comprises information satisfying a search request; and
the step of determining a match rating further comprises using the search request.

6. The method of claim 5, wherein the step of determining a match rating further comprises determining the search request based on the first organization profile.

7. The method of claim 5, wherein:
the step of determining a match rating further comprises receiving the search request from the first client device;
the search request comprises at least one of a search term and a search filter,
the search term comprises a text string received from the first client device; and
the search filter comprises a pre-determined term selected at the first client device.

8. The method of claim 1, wherein:
the ranking comprises at least one of an internal ranking and an external ranking;
the step of determining a ranking for each organization profile comprises:
determining a plurality of criterion for said organization profile; and
consolidating the plurality of criterion for said organization profile to obtain the ranking for said organization profile; and
the method further comprises:
storing, on the storage device, the ranking for the first organization profile in association with the first organization profile; and
storing, on the storage device, the ranking for the second organization profile in association with the second organization profile.

9. The method of claim 8, wherein
the ranking comprises an internal ranking;
the plurality of criterion comprises at least one of a subscription criterion and a marketing criterion;
the information about a corresponding organization further comprises at least one of a subscription selection and a marketing selection; and
the step of determining a plurality of criterion for said organization profile comprises assessing the at least one of a subscription selection and a marketing selection to determine the at least one of a subscription criterion and a marketing criterion.

10. The method of claim 8, wherein
the ranking comprises an internal ranking;
the plurality of criterion comprises an endorsements criterion; and
the step of determining a plurality of criterion for said organization profile comprises:
receiving at least one endorsement for said organization profile from a client device linked to a user account associated with an organization profile that is distinct from said organization profile;
storing, on the storage device, the at least one endorsement in association with said organization profile; and
assessing the at least one endorsement in association with said organization profile to determine the endorsements criterion.

11. The method of claim 8, wherein
the ranking comprises an internal ranking;
the plurality of criterion comprises a profile criterion; and
the step of determining a plurality of criterion for said organization profile comprises:
storing, on the storage device, a creation date of said organization profile; and
assessing said organization profile and the creation date of said organization profile to determine the profile criterion.

12. The method of claim 8, wherein
the ranking comprises an internal ranking;
the plurality of criterion comprises an activity criterion; and
the step of determining a plurality of criterion for said organization profile comprises:
maintaining, on the storage device, an activity log associated with said organization profile; and
assessing the activity log associated with said organization profile to determine the activity criterion.

13. The method of claim 8, wherein
the ranking comprises an internal ranking;
the plurality of criterion comprises a contacts criterion; and
the step of determining a plurality of criterion for said organization profile comprises:
receiving at least one contact acceptance between said organization profile and at least one distinct organization profile that is distinct from said organization profile, the contact acceptance being received from a client device linked to a user account associated with at least one of said organization and the at least one distinct organization profile;
storing, on the storage device, a contact connection for said organization profile in association with each of the at least one organization profile that is distinct from said organization profile of the at least one contact acceptance; and
assessing contact connections for said organization profile to determine the contacts criterion.

14. The method of claim 8, wherein
the ranking comprises an external ranking;
the step of determining a plurality of criterion for said organization profile comprises:
determining an industry identifier of said organization profile, and
accessing a network to obtain information related to said organization profile and not stored on the storage device; and
the step of consolidating the plurality of criterion for said organization profile to obtain the ranking is based on the industry identifier.

15. The method of claim 14, wherein
the plurality of criterion comprises at least one of a financials criterion, a quality criterion, an innovation criterion, a corporate social responsibility criterion, a company longevity criterion, a pricing criterion, and a social media verification criterion; and
the step of accessing a network to obtain information related to said organization profile and not stored on the storage device comprises accessing at least one of a website hosted by an organization corresponding to said organization profile and a social media profile corresponding to said organization profile.

16. The method of claim 14, wherein
the plurality of criterion comprises at least one of a stock price criterion, a reputation criterion, the quality criterion, the innovation criterion, the corporate social responsibility criterion, a performance criterion, and the pricing criterion; and
the step of accessing a network to obtain information related to said organization profile and not stored on the storage device comprises accessing a website hosted a third-party organization that does not correspond to said organization profile.

17. The method of claim 8, wherein
the ranking comprises an internal ranking;
the plurality of criterion comprises a growth criterion; and
the step of determining a plurality of criterion for said organization profile comprises:
storing, on the storage device, an initial external ranking for said organization profile in association with the first organization profile;
determining an external ranking for said organization profile; and
assessing the initial external ranking and the determined external ranking to determine the growth criterion.

18. The method of claim 2 further comprising:
maintaining, on the storage device, a plurality of opportunity postings, each opportunity posting being associated with a posting organization profile;
maintaining, on the storage device, a plurality of committed opportunities and a plurality of completed transactions, each committed opportunity and completed transaction being associated with at least two organization profiles;
in response to receiving an opportunity response corresponding to an opportunity posting, displaying at a posting client device linked to a user account associated with the posting organization profile of said opportunity posting, a posting graphical user interface comprising the opportunity response, the opportunity response being received from a responding client device linked to a user account associated with a responding organization profile, the responding organization profile being distinct from the posting organization profile;
in response to receiving a response acceptance corresponding to an opportunity response and an opportunity posting, the response acceptance being received from the posting client device,
removing, from the storage device, the opportunity posting, and
storing, on the storage device, a committed opportunity in association with the responding organization profile and the posting organization profile; and
in response to receiving an opportunity completion notice corresponding to a committed opportunity, the opportunity completion notice being received from at least one of the posting client device and the responding client device,
removing, from the storage device, the committed opportunity from the plurality of committed opportunities;
storing, on the storage device, a completed transaction in association with the posting organization profile and the responding organization profile; and
displaying, at the posting client device and the responding client device, an endorsements graphical user interface comprising an endorsement request.

19. The method of claim 18, wherein:
the step of determining a ranking for each of the first organization profile and the second organization profile further comprises receiving an opportunity request from the first client device;
the second organization profile is associated with a first opportunity posting satisfying the opportunity request; and
the first graphical user interface further comprises a total number of opportunity postings associated with the second organization profile.

20. The method of claim 18, wherein
the ranking comprises an internal ranking; and
the step of determining a ranking for each organization profile comprises:
determining a plurality of criterion for said organization profile;
consolidating the plurality of criterion for said organization profile to obtain the ranking for said organization profile, the plurality of criterion comprises a transactions criterion; and
assessing the opportunity postings, opportunity responses, committed opportunities, and completed transactions in association with said organization profile to determine the transactions criterion.

21. A non-transitory computer-readable storage medium having instructions stored thereon for execution by one or more processors for implementing a method comprising:
storing, on a storage device, a plurality of organization profiles and a plurality of user accounts, each organization profile being associated with at least one user account, each organization profile comprising Information about a corresponding organization, wherein the information is received from a client device linked to a user account associated with that organization profile;
determining a ranking for each of a first organization profile and a second organization profile; and
displaying at a first client device linked to a user account associated with the first organization profile, a first graphical user interface comprising the ranking for the second organization profile and the second organization profile.

22. The non-transitory computer-readable storage medium of claim 21, wherein the method further comprises:
the step of determining a ranking for each of a first organization profile and a second organization profile further comprises determining a match rating between the first organization profile and the second organization profile using the first organization profile, the second organization profile, and the rankings for the first organization profile and the second organization profile; and
the first graphical user interface further comprises the match rating.

23. The non-transitory computer-readable storage medium of claim 21, wherein:
the second organization profile comprises information satisfying a search request; and
the step of determining a match rating further comprises using the search request.

24. The non-transitory computer-readable storage medium of claim 21, wherein:
the ranking comprises at least one of an internal ranking and an external ranking;
the step of determining a ranking for each organization profile comprises:
determining a plurality of criterion for said organization profile; and
consolidating the plurality of criterion for said organization profile to obtain the ranking for said organization profile; and
the method further comprises:
storing, on the storage device, the ranking for the first organization profile in association with the first organization profile; and
storing, on the storage device, the ranking for the second organization profile in association with the second organization profile.

25. The non-transitory computer-readable storage medium of claim 21, wherein the method further comprises:
maintaining, on the storage device, a plurality of opportunity postings, each opportunity posting being associated with a posting organization profile;
maintaining, on the storage device, a plurality of committed opportunities and a plurality of completed transactions, each committed opportunity and completed transaction being associated with at least two organization profiles;
in response to receiving an opportunity response corresponding to an opportunity posting, displaying at a posting client device linked to a user account associated with the posting organization profile of said opportunity posting, a posting graphical user interface comprising the opportunity response, the opportunity response being received from a responding client device linked to a user account associated with a responding organization profile, the responding organization profile being distinct from the posting organization profile;
in response to receiving a response acceptance corresponding to an opportunity response and an opportunity posting, the response acceptance being received from the posting client device,
removing, from the storage device, the opportunity posting, and
storing, on the storage device, a committed opportunity in association with the responding organization profile and the posting organization profile; and
in response to receiving an opportunity completion notice corresponding to a committed opportunity, the opportunity completion notice being received from at least one of the posting client device and the responding client device,
removing, from the storage device, the committed opportunity from the plurality of committed opportunities;
storing, on the storage device, a completed opportunity in association with the posting organization profile and the responding organization profile; and
displaying, at the posting client device and the responding client device, an endorsements graphical user interface comprising an endorsement request.

26. A system comprising:
a processor; and
a non-transitory computer-readable storage medium having instructions stored thereon for implementing the method of claim 1.
